(19) United States
(12) Patent Application Publication
(10) Pub. No.: US 2021/0293089 A1
(43) Pub. Date: Sep. 23, 2021

(54) RELEASE MECHANISM FOR A GATE OR OTHER APPARATUS SUBJECT TO BEING IMPACTED

(71) Applicant: Vincent SHEBIB LOISELLE, Montreal (CA)

(72) Inventor: Vincent SHEBIB LOISELLE, Montreal (CA)

(21) Appl. No.: 17/208,902

(22) Filed: Mar. 22, 2021

Related U.S. Application Data
(60) Provisional application No. 62/992,846, filed on Mar. 20, 2020.

(51) Int. Cl. E06B 11/02

(52) U.S. Cl. CPC E06B 11/022

(57) ABSTRACT

A gate for controlling oncoming traffic on a roadway, in which an arm of the gate is releasable (e.g., detachable) when the arm is in an extended position and impacted by a vehicle such as a heavy truck, bus or other large vehicle, so as to enhance safety and reusability of the gate. Different modes of releasing (e.g., detaching) the arm may be used depending on where the arm is impacted and mechanics involved (e.g., bending moment and shear force). Also disclosed are other apparatuses in which other traffic-related devices (e.g., signs) or other impactable devices are releasable (e.g., detachable) when impacted.

### FIELD

This disclosure relates to managing impacts such as of vehicles on gates, signage systems, or other traffic-related equipment or on other impactable structures (e.g., for safety and/or reusability).

### BACKGROUND

Various kinds of apparatuses risk being impacted by vehicles or other objects, due to their function, location, etc.

For example, road closure gates are used for controlling oncoming traffic on a roadway, notably by informing the oncoming traffic that at least part of the roadway is closed, for lane closure (i.e., dosing a lane, such as a highway lane, a high-occupancy toll (HOT) lane, a high-occupancy vehicle (HOV) lane, etc.), ramp access control (e.g., on-ramp or off-ramp access control), tunnel/bridge closure, work-zone lane closure, weather-related access control, and other traffic control measures.

Unlike resistance gates (also sometimes referred to as “resistance barriers” or “final barriers”), certain road closure gates (e.g., sometimes referred to as warning gates) are “forgiving” in that they allow oncoming vehicles to pass through them if crashed into, i.e., are not designed to stop the oncoming vehicles.

Existing road closure gates are useful but may sometimes be limited in how they can be used. For example, in some cases, a gate may be limited in length and visibility and thus in its ability to dose more of a roadway because of issues that would arise from additional weight, including greater forces to support it and potential for greater damage and injury if crashed into. Some gates may be highly visible but limited in length, while others may be longer but inadequately visible for some purposes (e.g., highways or other high-speed facilities), For larger vehicles (e.g., heavy trucks, buses or other vehicles larger than pickup trucks), impacts may create more damage and/or hazards to other vehicles.

Other traffic-related equipment, such as signs, may also present similar challenges in some cases.

Similar considerations may sometimes arise for other apparatuses used for purposes other than traffic management.

For these and other reasons, there is a need to improve gates, signage systems, or other traffic-related equipment or other apparatuses that are subject to impacts.

### SUMMARY

According to various aspects of this disclosure, there is provided a gate for controlling oncoming traffic on a roadway, in which an arm of the gate is releasable (e.g., detachable) when the arm is in an extended position and impacted by a vehicle such as a heavy truck, bus or other large vehicle, so as to enhance safety and reusability of the gate. Different modes of releasing (e.g., detaching) the arm may be used depending on where the arm is impacted and mechanics involved (e.g., bending moment and shear force). Also provided are other apparatuses in which other traffic-related devices (e.g., signs) or other impactable devices are releasable (e.g., detachable) when impacted.

For example, in accordance with an aspect of this disclosure, there is provided a gate for controlling oncoming traffic on a roadway. The gate comprises an arm movable between an extended position in which the arm extends into a given portion of the roadway to inform the oncoming traffic that the given portion of the roadway is dosed and a retracted position in which the arm does not extend into the given portion of the roadway. The gate also comprises a control system comprising an actuator and configured to support the arm and move the arm between the extended position and the retracted position. The control system comprising a release mechanism configured to release the arm when the arm is in the extended position and impacted by a vehicle. The release mechanism is configured to release the arm in any one of a plurality of release modes that are different based on where the arm is impacted by the vehicle.

In accordance with another aspect of this disclosure, there is provided a gate for controlling oncoming traffic on a roadway, The gate comprises an arm movable between an extended position in which the arm extends into a given portion of the roadway to inform the oncoming traffic that the given portion of the roadway is dosed and a retracted position in which the arm does not extend into the given portion of the roadway. The gate also comprises a control system comprising an actuator. The control system is configured to support the arm and move the arm between the extended position and the retracted position. The control system also comprises a release mechanism configured to release the arm when the arm is in the extended position and impacted by a vehicle. The release mechanism is configured to release the arm at least mainly due to a bending moment at the release mechanism when the arm is impacted by the vehicle at a first location and at least mainly due to a shear force at the release mechanism when the arm is impacted by the vehicle at a second location closer to the control system than the first location.

In accordance with another aspect of this disclosure, there is provided a gate for controlling oncoming traffic on a roadway. The gate comprises an arm movable between an extended position in which the arm extends into a given portion of the roadway to inform the oncoming traffic that the given portion of the roadway is dosed and a retracted position in which the arm does not extend into the given portion of the roadway. The gate also comprises a control system comprising an actuator. The control system is configured to support the arm and move the arm between the extended position and the retracted position, The control system also comprises a release mechanism configured to detach the arm from the control system when the arm is in the extended position and impacted by a vehicle. The release mechanism is configured to detach the arm from the control system in response to a bending moment at the release mechanism.

In accordance with another aspect of this disclosure, there is provided a gate for controlling oncoming traffic on a roadway. The gate comprises an arm movable between an extended position in which the arm extends into a given portion of the roadway to inform the oncoming traffic that the given portion of the roadway is dosed and a retracted position in which the arm does not extend into the given portion of the roadway. The gate also comprises a control system comprising an actuator. The control system is configured to support the arm and move the arm between the extended position and the retracted position. The control system comprises a release mechanism configured to detach the arm from the control system when the arm is in the extended position and impacted by a vehicle.

In accordance with another aspect of this disclosure, there is provided an apparatus for use in respect of traffic on a roadway. The apparatus comprises a traffic-related device configured to be disposed at the roadway. The apparatus also comprises a release mechanism configured to release the traffic-related device when the traffic-related device is impacted by a vehicle. The release mechanism is configured to release the traffic-related device in any one of a plurality of release modes that are different based on where the traffic-related device is impacted by the vehicle.

In accordance with another aspect of this disclosure, there is provided an apparatus for use in respect of traffic on a roadway, The apparatus comprises a traffic-related device configured to be disposed at the roadway. The apparatus also comprises a release mechanism configured to release the traffic-related device when the traffic-related device is impacted by a vehicle. The release mechanism being configured to release the traffic-related device: at least mainly due to a bending moment at the release mechanism when the traffic-related device is impacted by the vehicle at a first location and at least mainly due to a shear force at the release mechanism when the traffic-related device is impacted by the vehicle at a second location different from the first location.

In accordance with another aspect of this disclosure, there is provided an apparatus for use in respect of traffic on a roadway. The apparatus comprises a traffic-related device configured to be disposed at the roadway. The apparatus also comprises a release mechanism configured to detach the traffic-related device when the traffic-related device is impacted by a vehicle. The release mechanism is configured to detach the traffic-related device in response to a bending moment at the release mechanism.

In accordance with another aspect of this disclosure, there is provided an apparatus for use in respect of traffic on a roadway. The apparatus comprises a traffic-related device configured to be disposed at the roadway. The apparatus also comprises a release mechanism configured to detach the traffic-related device when the traffic-related device is in the extended position and impacted by a vehicle.

In accordance with another aspect of this disclosure, there is provided an apparatus comprising an impactable device subject to being impacted. The apparatus also comprises a release mechanism configured to release the impactable device when the impactable device is impacted. The release mechanism is configured to release the impactable device in any one of a plurality of release modes that are different based on where the impactable device is impacted.

In accordance with another aspect of this disclosure, there is provided an apparatus comprising an impactable device subject to being impacted. The apparatus also comprises a release mechanism configured to release the impactable device when the impactable device is impacted. The release mechanism is configured to release the impactable device: at least mainly due to a bending moment at the release mechanism when the impactable device is impacted at a first location and at least mainly due to a shear force at the release mechanism when the impactable device is impacted at a second location different from the first location.

These and other aspects of this disclosure will now become apparent to those of ordinary skill in the art upon review of the following description of embodiments in conjunction with the accompanying drawings.

### BRIEF DESCRIPTION OF DRAWINGS

A detailed description of embodiments is provided below, by way of example only, with reference to the accompanying drawings, in which:

FIG. 1 shows an example of a gate for controlling oncoming traffic on a roadway in accordance with an embodiment, in which an arm of the gate is in an extended position;

FIG. 2 shows the arm of the gate in a retracted position;

FIGS. 3 and 4 show the gate in relation to vehicles;

FIG. 5 shows part of the gate, including part of a beam of the gate;

FIGS. 6, 7A and 7B show examples of deflections of the arm about a horizontal axis and a vertical axis;

FIGS. 8 to 10 show part of a control system of the gate;

FIGS. 11 to 13 shows block diagrams illustrating components of the control system;

FIGS. 14A and 14B show the gate comprising the control system that comprises a release mechanism;

FIG. 14C shows an enlarged view of a release mechanism of a cable of the arm according to another embodiment;

FIG. 15A shows an enlarged view of the release mechanism of FIGS. 14A and 14B;

FIGS. 15B and 15C show an alignment device and a plate of the release mechanism according to another embodiment;

FIGS. 16A, 16B and 16C show the arm detaching from the control system as one piece in front of a vehicle;

FIG. 17 shows a first release mode of the release mechanism;

FIG. 18 shows a second release mode of the release mechanism;

FIGS. 19 and 20 show the arm of the gate impacted by a vehicle at a first location, a second location, and between the first location and the second location;

FIGS. 21A and 21B show a frangible connection of an arm carrier and a base comprising a plurality of fasteners according to another embodiment;

FIGS. 22A and 22B show an embodiment of a given one of the plurality of fasteners of the connection of the arm carrier and the base comprising a zone of weakness;

FIGS. 22C and 22D shows another embodiment of the given one of the plurality of fasteners;

FIG. 22E shows another embodiment of a given one of the plurality of fasteners of the connection of the arm carrier and the base and a washer engaging the given one of the fasteners;

FIG. 22F shows another embodiment of a given one of the plurality of fasteners of the connection of the arm carrier comprising a recess;

FIGS. 23 and 24 show an example of an embodiment in which a beam of the arm comprises beam segments that are interconnected;

FIGS. 25 to 28 show examples of connectors interconnecting adjacent beam segments of the beam in other embodiments;

FIGS. 29 to 31 show examples of a connection of the arm to the control system in some embodiments;

FIGS. 32 to 34 show additional examples of connectors interconnecting adjacent beam segments of the beam in other embodiments;

FIGS. 35 to 37 show additional examples of a connection between the beam and the control system in other embodiments;

FIGS. 38A and 38B show an embodiment of a given one of the plurality of fasteners of the connection of the arm carrier and the base comprising a first zone of weakness and a second zone of weakness;

FIGS. 39A,39B, 39C and 39D show an embodiment of a given one of the plurality of fasteners of the connection of the arm carrier and the base comprising a first zone of weakness, a second zone of weakness and a third zone of weakness;

FIGS. 40A, 40B and 40C show an embodiment of a fastener comprising zones of directional weakness;

FIG. 40D shows another embodiment of a fastener comprising zones of directional weakness;

FIGS. 41A and 41B show an embodiment of the release mechanism comprising a third supporting member comprising a first and a second zone of weakness and a fourth supporting member comprising a first and a second zone of weakness;

FIGS. 42A and 42B show a first and a second release mode of the release mechanism of FIGS. 41A and 41B;

FIG. 42C shows another embodiment of the release mechanism comprising a third supporting member comprising a first and a second zone of weakness and a fourth supporting member comprising a first and a second zone of weakness;

FIGS. 42D and 42E show a first and a second release mode of the release mechanism of FIG. 42C;

FIG. 43 shows an embodiment of the connection of the arm carrier and the base comprising a plurality of welds;

FIGS. 44, 45A, 45B, 45C and 45D show examples of embodiments in which properties of the beam vary along a length of the beam;

FIG. 46 shows an example of another embodiment of the beam;

FIGS. 47 to 52 show another example of another embodiment of the arm;

FIGS. 53 and 54 show examples of a sign of the arm;

FIGS. 55 to 61 show an example of another embodiment of the control system;

FIG. 62 shows an example of a variant in which the arm comprises an aluminum truss; and

FIGS. 63 to 71 show an example of a variant in which the arm is movable vertically relative to the control system;

FIGS. 72A and 72B show embodiments of a signage apparatus; and

FIGS. 73A to 75D show various embodiments of the release mechanism;

It is to be expressly understood that the description and drawings are only for the purpose of illustrating certain embodiments and are an aid for understanding. They are not intended to be limitative.

### DETAILED DESCRIPTION OF EMBODIMENTS

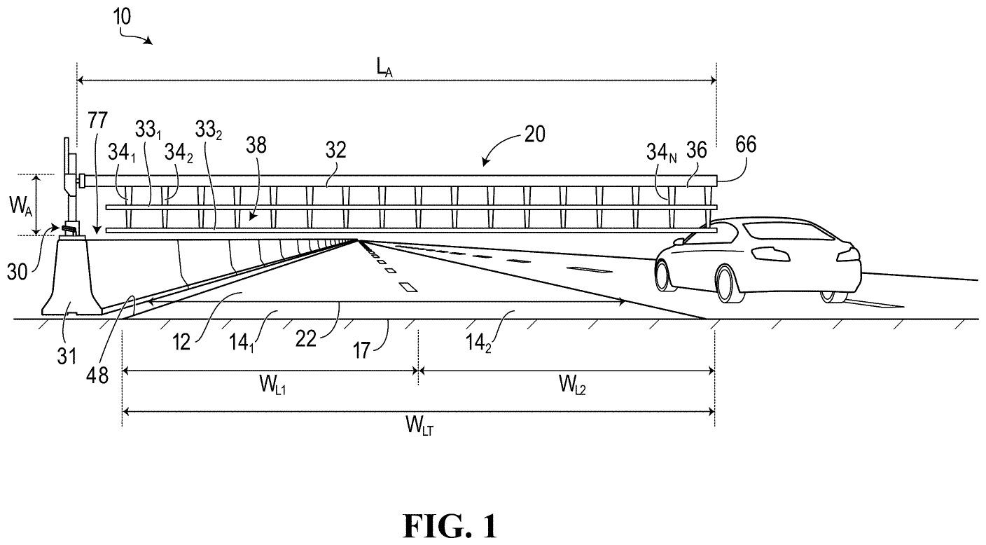

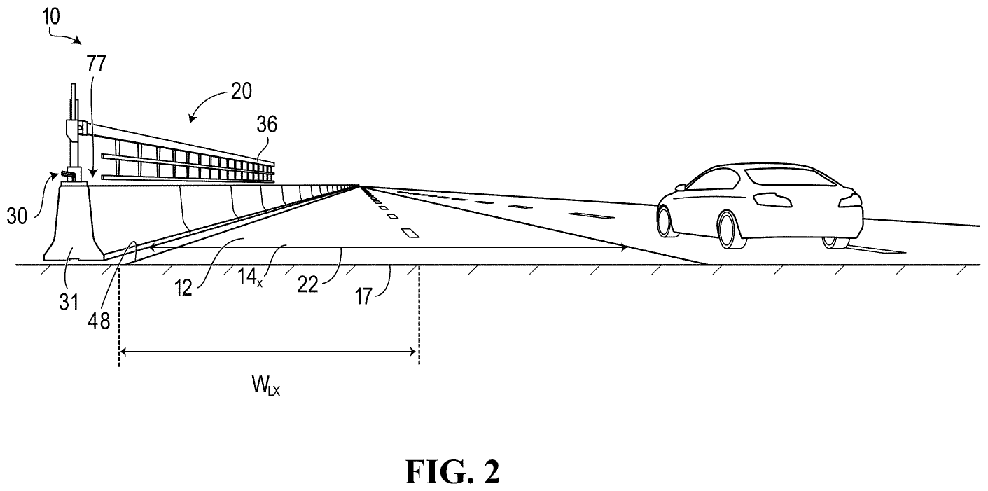

FIGS. 1 and 2 show an embodiment of an apparatus 10 comprising an impactable device 20 subject to being impacted (i.e., at risk of experiencing an impact with another object). In this embodiment, the apparatus 10 is for use in respect of traffic on a roadway 12 and the impactable device 20 is a traffic-related device configured to manage, assist or otherwise affect the traffic on the roadway 12. More particularly, in this embodiment, the apparatus 10 is a gate for controlling the traffic, which is oncoming traffic, on the roadway 12. The gate 10 is configured to inform the oncoming traffic, which may include passenger cars, trucks, and/or other motor vehicles travelling on a surface 17 of the roadway 12, that at least part of the roadway 12 is dosed. In this example, unlike resistance gates (also sometimes referred to as “resistance barriers” or “final barriers”), the gate 10 is “forgiving” in that it allows an oncoming vehicle to pass through it if crashed into, i.e., is not designed to stop the oncoming vehicle.

In this embodiment, the gate 10 is used for lane closure, i.e., dosing one or more lanes, such as highway lanes, express lanes, high-occupancy toll (HOT) lanes, high-occupancy vehicle (HOV) lanes, and/or other lanes of the roadway 12. In other embodiments, the gate 10 may be used for other traffic control measures, such as ramp access control (e.g., on-ramp or off-ramp access control), tunnel/bridge closure, work-zone lane closure, weather-related access control, etc.

Thus, in this embodiment, the traffic-related device 20 of the gate 10 is an arm movable between (i) an extended position in which the arm 20 extends into a given portion 22 of the roadway 12 to inform the oncoming traffic that the given portion 22 of the roadway 12 is dosed, as shown in FIG. 1, and (ii) a retracted position in which the arm 20 does not extend into the given portion 22 of the roadway 12 and thus leaves open the given portion 22 of the roadway 12 for the oncoming traffic, as shown in FIG. 2. The arm 20 has a longitudinal direction, which defines a length L_{A} of the arm 20 in its extended position, and a widthwise direction, which is generally vertical and defines a width W_{A} of the arm 20 in its extended position.

As shown in FIGS. 1 and 2, the gate 10 also comprises a control system 30 configured to support the arm 20 and move the arm 20 between its extended position and its retracted position. The arm 20 is cantilevered at the control system 30 in its extended position. In this embodiment, the control system 30 is mounted to a traffic barrier 31 for the roadway 12. In this example, the traffic barrier 31 is a median barrier between opposite traffic directions for the roadway 12.

In this embodiment, as further discussed later, the arm 20 may be quite long and vertically wide to dose more of the roadway 12 and be dearly visible to the oncoming traffic, while the gate 10 may be crash-tested (i.e., compliant with crash-testing criteria), its control system 30 may be compact, and the gate 10 may be reusable and easily repairable if crashed into. Notably, in this embodiment, the control system 30 is configured to release the arm 20 (e.g., detach the arm 20 from the control system 30) when the arm 20 is in its extended position and impacted by a vehicle such as a heavy truck, a bus or other large vehicle, so as to enhance safety and reusability of the gate 10. Different modes of releasing (e.g., detaching) the arm 20 may be used depending on where the arm 20 is impacted and mechanics involved (e.g., bending moment and shear force).

In this example, the gate 10 is used to close one or more of a plurality of lanes 14₁-14_{L} of the roadway 12. The given portion 22 of the roadway 12 to be dosed by the arm 20 thus includes at least one of the lanes 14₁-14_{L}. In this embodiment, the arm 20 is configured to be longer than a width W_{Lx} of a lane 14ₓ that it can dose in its extended position. More particularly, in this embodiment, the given portion 22 of the roadway 12 to be dosed by the arm 20 includes plural ones of the lanes 14₁-14_{L}, namely the lanes 14₁, 14₂. as shown in FIG. 1 In this example, the roadway 12 is a highway and the lanes 14₁, 14₂ that can be dosed by the arm 20 are express lanes. In this case, the arm 20 is configured to span the lanes 14₁, 14₂ in its extended position. That is, the arm 20 is configured to extend at least as long as a total width W_{LT} of the lanes 14₁, 14₂ (i.e., W_{L1}+W_{L2}) in its extended position. Also, in this example, the roadway 12 also includes a shoulder 48, and the given portion 22 of the roadway 12 to be closed by the arm 20 also includes the shoulder 48. In some cases, the roadway 12 may include another shoulder on an opposite side of the roadway 12, and both shoulders may be closed by the arm 20.

The length L_{A} of the arm 20 in its extended position may thus be significant. For example, in some embodiments, the length L_{A} of the arm 20 in its extended position may be at least 20 feet (ft) (about 6.1 meters (m)), in some cases at least 25 ft (about 7.6 m), in some cases at least 30 ft (about 9.1 m), in some cases at least 35 ft (about 10.7 m), in some cases at least 40 ft (about 12.2 m), and in some cases even greater. In this example, the length L_{A} of the arm 20 in its extended position is 30 ft. In this case, the length L_{A} of the arm 20 in its extended position is at least as long as the total width W_{LT} of the lanes 14₁, 14₂ (i.e., L_{A}≥W_{L1}+W_{L2}).

In some embodiments, in order to progressively divert the oncoming traffic away from the lanes 14₁, 14₂ being closed, a series of other gates similar and shorter than the gate 10 but gradually longer from one to another may be placed along the roadway 12 before the gate 10 (e.g., each of these other gates may be 4 ft, 10 ft, or 15 ft long, or any other length).

The width W_{A} of the arm 20 in its extended position may also be significant, notably to make the arm 20 clearly visible to the oncoming traffic. For example, in some embodiments, the width W_{A} of the arm 20 in a vertical direction in its extended position may be at least 15 inches (about 38 cm), in some cases at least 20 inches (about 50 cm), in some cases at least 30 inches (about 76 cm), in some cases at least 40 inches (about 1 m), and in some cases even more.

In some embodiments, the width W_{A} of the arm 20 may be such that the arm 20 is relatively close to a top 77 of the traffic barrier 31 when the arm 20 is in its retracted position. For instance, in some embodiments, the width W_{A} of the arm 20 may be such that the arm 20 is within 8 inches, in some cases 6 inches, in some cases 4 inches, in some cases within 2 inches, and in some cases even closer to the top 77 of the traffic barrier 31 when the arm 20 is in its retracted position.

The width W_{A} of the arm 20 which may be significant for visibility of the arm 20 to the oncoming traffic can also be expressed in relation to the length L_{A} of the arm 20. For example, in some embodiments, a ratio of the width W_{A} of the arm 20 in its extended position over the length L_{A} of the arm 20 in its extended position may be at least 5%, in some cases at least 8%, in some cases at least 10%, in some cases at least 15%, and in some cases even more.

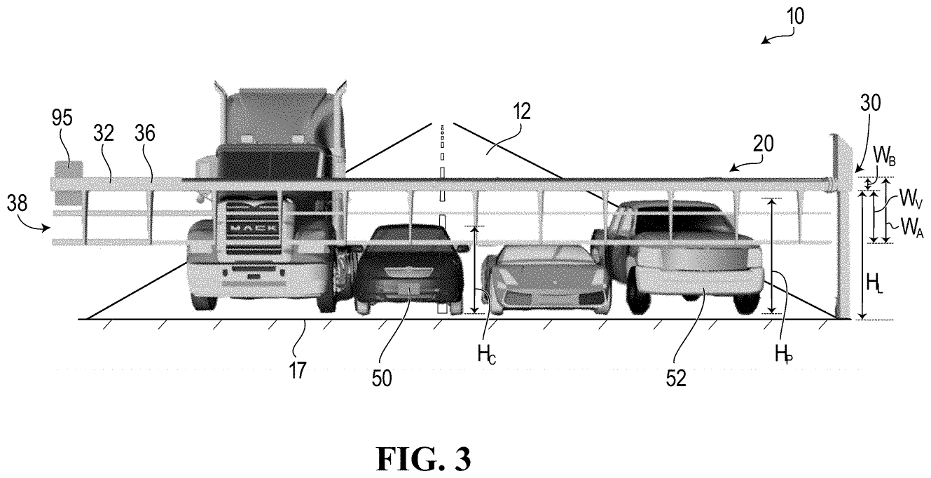

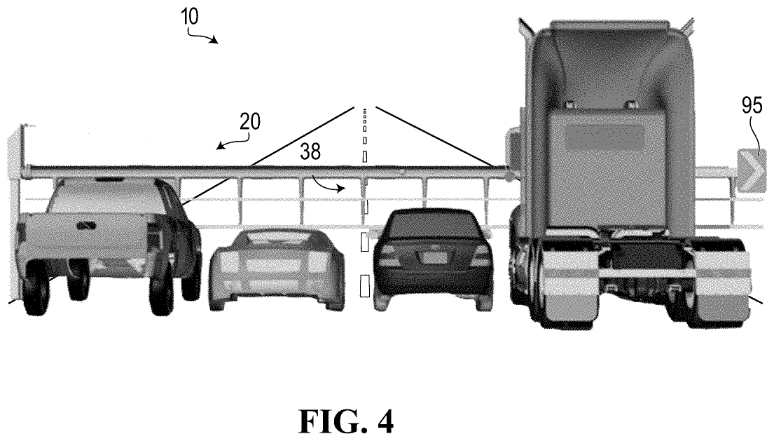

With additional reference to FIGS. 3 and 4, in this embodiment, a longitudinal part 36 of the arm 20 in its extended position may be located relatively high with respect to the surface 17 of the roadway 12. This may help the gate 10 to be crashworthy. For instance, this may allow positioning what imparts structural integrity of the arm 20 sufficiently high to clear vehicles (e.g., passenger cars and pickup trucks) that would crash into the gate 10. This may be particularly useful given that the arm 20 may be quite long and vertically wide (e.g., the longitudinal part 36 of the arm 20 may be stiff in order for the arm 20 to stay straight, and so placing it high may help the gate 10 to be crashworthy).

For example, in some embodiments, a height H_{L} of the longitudinal part 36 of the arm 20 in its extended position from the surface 17 of the roadway 12, as shown in FIG. 3, may be at least 55 inches (about 1.4 m), in some cases at least 60 inches (about 1.5 m), in some cases at least 65 inches (about 1.65 m), in some cases at least 70 inches (about 1.8 m), in some cases at least 75 inches (about 1.9 m), in some cases at least 80 inches (about 2.03 m) and in some cases even more (e.g., up to 14 ft).

The width W_{A} of the arm 20 which may be significant for visibility of the arm 20 to the oncoming traffic can also be expressed in relation to the height HL of the longitudinal part 36 of the arm 20 from the surface 17 of the roadway 12. For instance, in some embodiments, a ratio of the width W_{A} of the arm 20 in its extended position over the height HL of the longitudinal part 36 of the arm 20 in its extended position from the surface 17 of the roadway 12 may be at least 0.2, in some cases at least 0.4, in some cases at least 0.6, and in some cases even more.

In this embodiment, the gate 10 is crash-tested, i.e., compliant with crash-testing criteria. More particularly, in this embodiment, the gate 10 is MASH crash-tested, i.e., compliant with crash-testing criteria of MASH, which is the Manual for Assessing Safety Hardware produced by the American Association of State Highway and Transportation Officials (AASHTO), published as a 2^{nd} edition in 2016, accessible at https://bookstore.transportation.org/, and incorporated by reference herein.

For example, in some embodiments, the gate 10 may be compliant with (i.e., be able to successfully pass all) MASH evaluation criteria of Test Level 3 Support Structures test matrices and/or MASH evaluation criteria of Test Level 3 Work Zone Traffic Control Devices test matrices.

As may be better seen in FIGS. 3 and 4, in this embodiment, the height

HL of the longitudinal part 36 of the arm 20 from the surface 17 of the roadway 12 is greater than a height H_{c} of a passenger car 50 complying with MASH crash-testing. More particularly, in this embodiment, the height H_{L} of the longitudinal part 36 of the arm 20 from the surface 17 of the roadway 12 is no less than a height Hₚ of a pickup truck 52 complying with MASH crash-testing. In this case, the height H_{L} of the longitudinal part 36 of the arm 20 from the surface 17 of the roadway 12 is greater than the height Hₚ of the pickup truck 52 complying with MASH crash-testing.

The arm 20 may be constructed in any suitable way. In this embodiment, the arm 20 comprises a beam 32 extending along the longitudinal direction of the arm 20 and a visible arrangement 38 supported by the beam 32.

In this embodiment, the beam 32 provides the structural integrity of the arm 20 and comprises the longitudinal part 36 of the arm 20 significantly elevated relative to the surface 17 of the roadway 12. In this example, the beam 32 is a sole beam of the arm 20. That is, the arm 20 is free of (i.e., without) any other beam that extends along its longitudinal direction for its structural integrity.

The beam 32 may include any suitable material. In this embodiment, the beam 32 comprises a metallic material. More particularly, in this embodiment, the metallic material of the beam 32 is aluminum. The beam 32 may include any other suitable metallic material (e.g., steel) and/or any other nonmetallic material (e.g., polymeric material, including fiber-reinforced polymeric material, such as carbon-fiber-reinforced polymeric material) in other embodiments.

Also, the beam 32 may have any suitable cross-sectional shape. In this embodiment, the beam 32 has a circular cross-section. Also, in this embodiment, the beam 32 is hollow, i.e., comprises an internal cavity, to help reduce a weight of the beam 32 and thus a weight of the arm 20. In other embodiments, the beam 32 may have any other cross-section instead of or in addition to a circular one, such as another curved cross-section, a polygonal (e.g., rectangular, pentagonal, hexagonal, heptagonal, octagonal, etc.) cross-section, a U-shape cross-section, an H-shape cross-section, a T-shape cross-section, a V-shape cross-section, any other standard beam cross-sectional shape, a custom shape, etc.

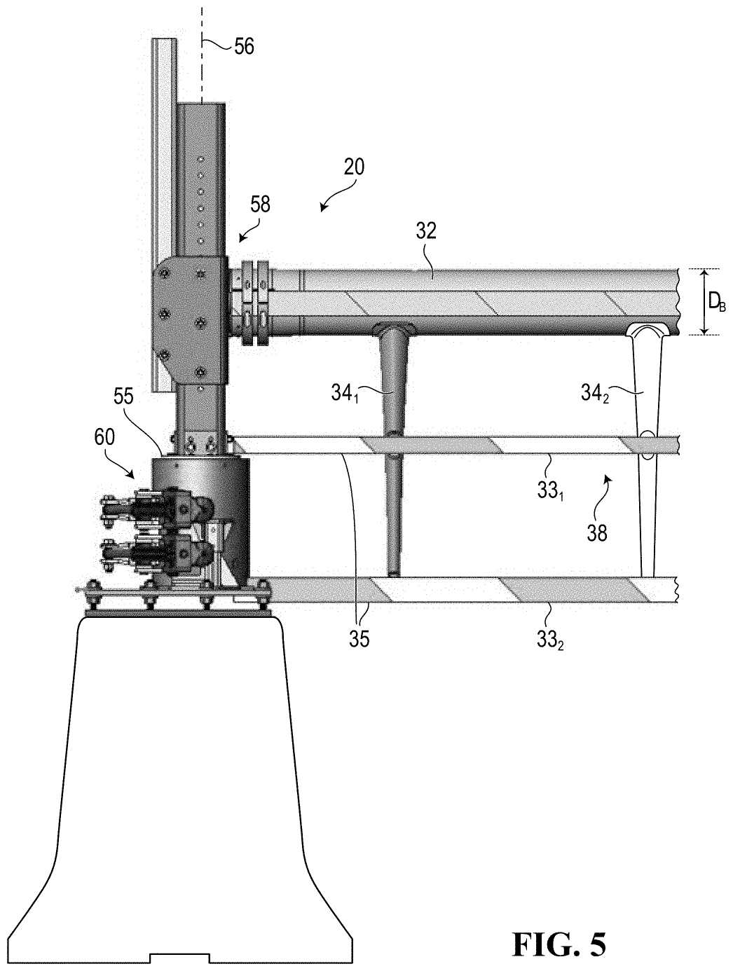

In this embodiment, considering that it provides the structural integrity of the arm 20, the beam 32 is dimensioned to make the arm 20 strong and stiff enough to support its weight (e.g., and possibly other loading from snow, ice, wind or other matter which may rest and/or exert force upon it) in its extended position without excessively deflecting, yet be light enough for operation by the control system 30. For instance, in some embodiments, a cross-sectional dimension DB of the beam 32 may be no more than 12 inches, in some cases no more than 10 inches, in some cases no more than 8 inches, in some cases no more than 6 inches, in some cases no more than 4 inches, and in some cases even less (e.g., 2 inches). In this example where the cross-section of the beam 32 is circular, the cross-sectional dimension DB of the beam 32 is a diameter of the beam 32, as shown in FIG. 5.

The visible arrangement 38 increases the visibility of the arm 20 to the oncoming traffic. In this embodiment, the visible arrangement 38 depends downwardly from the beam 32. In this example, the visible arrangement 38 is disruptable, i.e., deflectable or breakable, if crashed into by an oncoming vehicle without significantly damaging the oncoming vehicle. For instance, in this embodiment, disruption of the visible arrangement 38 by the oncoming vehicle avoids damaging the oncoming vehicle beyond what is permitted under MASH crash-testing (e.g., MASH windshield criteria regarding no tear of a plastic liner of the oncoming vehicle's windshield and a maximum deformation of 3 inches (76 mm), or MASH criteria regarding no detached elements, fragments or other debris from the visible arrangement and/or vehicular damage blocking the driver's vision or otherwise causing the driver to lose control of the vehicle).

More particularly, in this embodiment, a dimension W_{V} of the visible arrangement 38 in the widthwise direction of the arm 20 is greater than a dimension W_{B} of the beam 32 in the widthwise direction of the arm 20. For example, in some embodiments, the dimension W_{V} of the visible arrangement 38 in the widthwise direction of the arm 20 may be at least twice, in some cases at least thrice, and in some cases more than thrice the dimension W_{B} of the beam 32 in the widthwise direction of the arm 20. In this example, the dimension W_{V} of the visible arrangement 38 in the widthwise direction of the arm 20 is about four times the dimension WB of the beam 32 in the widthwise direction of the arm 20.

Also, in this embodiment, the dimension W_{V} of the visible arrangement 38 in the widthwise direction of the arm 20 corresponds to at least a majority of the dimension W_{A} of the arm 20. For instance, in some embodiments, the dimension W_{V} of the visible arrangement 38 in the widthwise direction of the arm 20 may correspond to at least half, in some cases at least two-thirds, in some cases at least three-quarters, and in some cases at least four-fifths of the dimension W_{A} of the arm 20.

The visible arrangement 38 may be implemented in any suitable way. In this embodiment, the visible arrangement 38 comprises a plurality of visible members 33₁, 33₂, 34₁-34_{N}. More particularly, in this embodiment, transversal ones of the visible members 33₁, 33₂, 34₁-34_{N} namely the transversal visible members 34₁-34_{N}, project from the beam 32, extend transversally to a longitudinal direction of the beam 32 and are spaced apart in the longitudinal direction of the beam 32, whereas longitudinal ones of the visible members 33₁, 33₂, 34₁-34_{N}, namely the longitudinal visible members 33₁, 33₂, extend and are elongated in the longitudinal direction of the beam 32 and are spaced apart in a widthwise direction of the beam 32.

In this embodiment, the transversal visible members 34₁-34_{N} depend downwardly from the beam 32. More particularly, in this embodiment, the transversal visible members 34₁-34_{N} extend substantially perpendicularly to the longitudinal direction of the beam 32. In this example, each of the transversal visible members 34₁-34_{N} comprises a post 34. The transversal visible members 34₁-34_{N} may be shaped in any other suitable way and/or different ones of the transversal visible members 34₁-34_{N} may be shaped differently in other embodiments.

Also, in this embodiment, the longitudinal visible members 33₁, 33₂ extend generally parallel to the longitudinal direction of the beam 32. The longitudinal visible members 33₁, 33₂ are reflective so that light reflects on them to increase the visibility of the visible arrangement 38 to the oncoming traffic. Any suitable reflective material may be used. In this example, each of the longitudinal visible members 33₁, 33₂ comprises a strip 35. The strip 35 may be flexible so that it can deflect easily if an oncoming vehicle crashes into the gate 10. In some cases, the strip 35 may be a one-piece strip, In other cases, the strip 35 may include a plurality of pieces that constitute longitudinally-extending segments and are interconnected. This may facilitate transportation, handling and installation at the roadway 12. The longitudinal visible members 33₁, 33₂ may be shaped in any other suitable way and/or different ones of the longitudinal visible members 33₁, 33₂ may be shaped differently in other embodiments.

In this embodiment, the visible arrangement 38 comprises one or more polymeric materials. More particularly, in this embodiment, the transversal visible members 34₁-34_{N} comprise a polymeric material (e.g., high-density polyethylene) and the longitudinal visible members 33₁, 33₂ comprises a different polymeric material (e.g., polycarbonate with a reflective layer, such as high-intensity retroreflective sheeting). Any other suitable material may be used for the visible arrangement 38 in other embodiments (e.g., any other polymeric material, composite material, etc. with high impact strength and high plastic deformation to bend instead of breaking upon impact).

The beam 32 and the visible arrangement 38 may be interconnected in any suitable way. In this embodiment, the transversal visible members 34₁-34_{N} are affixed to and extend downwardly from the beam 32, while the longitudinal visible members 33₁, 33₂ are affixed to and extend across respective ones of the transversal visible members 33₁, 33₂. Also, in this embodiment, at least part of the visible arrangement 38 may be easily replaceable without having to dismantle or replacing entirely the arm 20 when the gate 10 is crashed into (e.g., by a passenger car or pickup truck).

In this embodiment, the visible arrangement 38, including respective ones of the transversal visible members 34₁-34_{N}, is fastened to the beam 32 by one or more mechanical fasteners, such as rivets, bolts, screws or other threaded fasteners, or any other suitable mechanical fasteners (e.g., compression damps). Alternatively or additionally, in some embodiments, the visible arrangement 38 may be bonded to an external surface of the beam 32 by an adhesive (e.g., an acrylic, epoxy, urethane, elastomer, silicone, cyanoacrylate, etc.), ultrasonic welding or any other suitable bonding.

Also, in this embodiment, the longitudinal visible members 33₁, 33₂ may be secured to respective ones of the transversal visible members 34₁, 34₂ by one or more mechanical fasteners, such as rivets, bolts, screws or other threaded fasteners, or any other suitable mechanical fasteners. As an alternative or in addition, in some embodiments, the longitudinal visible members 33₁, 33₂ may be bonded to respective ones of the transversal visible members 34₁, 34₂ by an adhesive (e.g., an acrylic, epoxy, urethane, elastomer, silicone, cyanoacrylate, etc.), ultrasonic welding or any other suitable bonding,

The beam 32 and the visible arrangement 38 may thus be made of different materials with different properties. This may help for allowing the beam 20 to be long and vertically wide, yet support it at the control system 30 and enable the gate 10 to be crash-tested. For instance, in this embodiment, the beam 32 includes a metallic material and each of the visible members 331, 33₂, 34₁-34_{N} includes a polymeric material.

For example, in some embodiments, a material of the beam 32 (e.g., in this case, metallic material) may be denser than a material of the visible arrangement 38 (e.g., in this case, polymeric material), such as a material of each of the visible members 33₁, 33₂, 34₁-34_{N}. More particularly, in some embodiments, a ratio of a density of the material of the beam 32 over a density of the material of the visible arrangement 38 (e.g., a density of the material of each of the visible members 33₁, 33₂, 34₁-34_{N}) may be at least 1.2, in some cases at least 1.5, in some cases at least 2, in some cases at least 4, and in some cases even more.

Also, in some embodiments, the beam 32 may be stiffer than the visible arrangement 38 in a direction of the oncoming traffic. For instance, a material of the beam 32 (e.g., in this case, metallic material) may be stiffer than a material of the visible arrangement 38 (e.g., in this case, polymeric material), such as a material of each of the visible members 33₁, 33₂, 34₁-34_{N}. For example, in some embodiments, a ratio of a modulus of elasticity (i.e., Young's modulus) of the material of the beam 32 over a modulus of elasticity of the material of the visible arrangement 38 (e.g., a modulus of elasticity of the material of each of the visible members 33₁, 33₂, 34₁-34_{N}) may be at least 5, in some cases at least 10, in some cases at least 20, in some cases at least 50, in some cases at least 100, and in some cases even more.

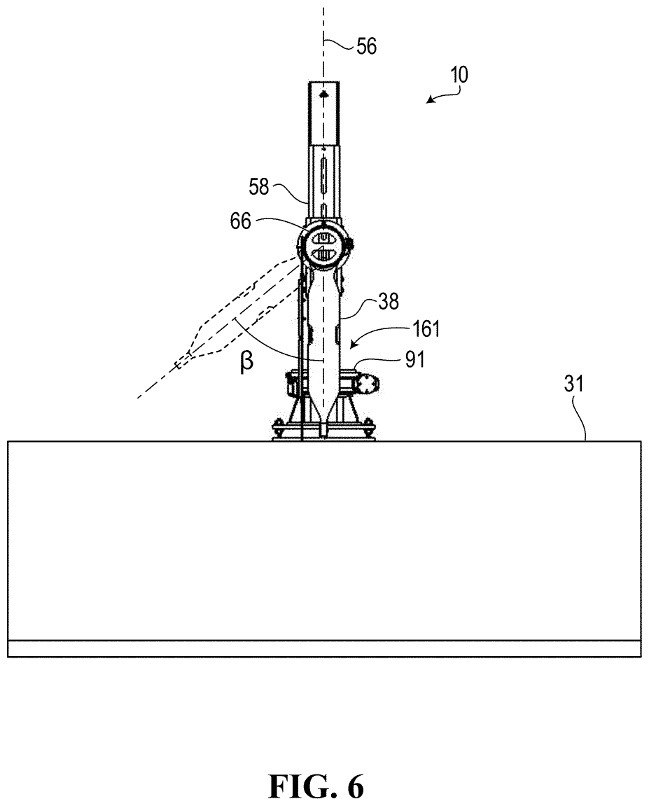

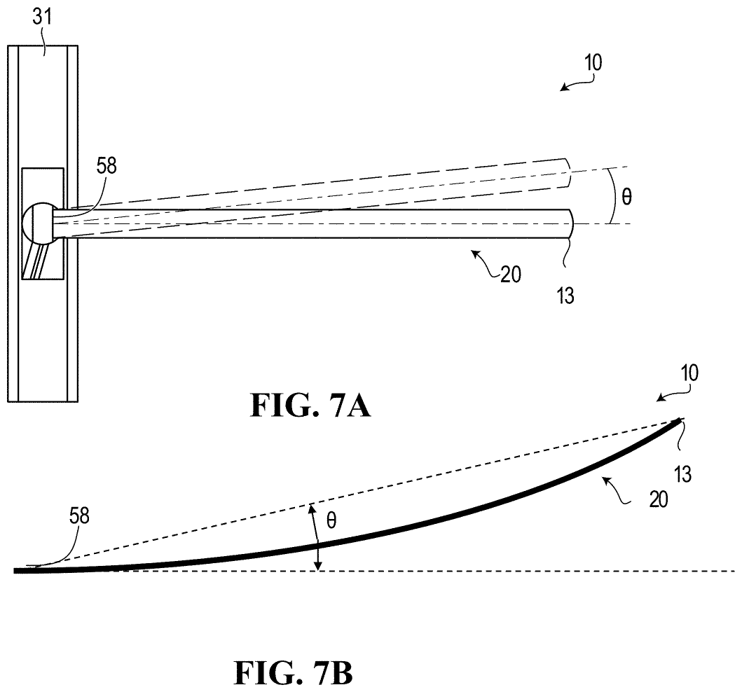

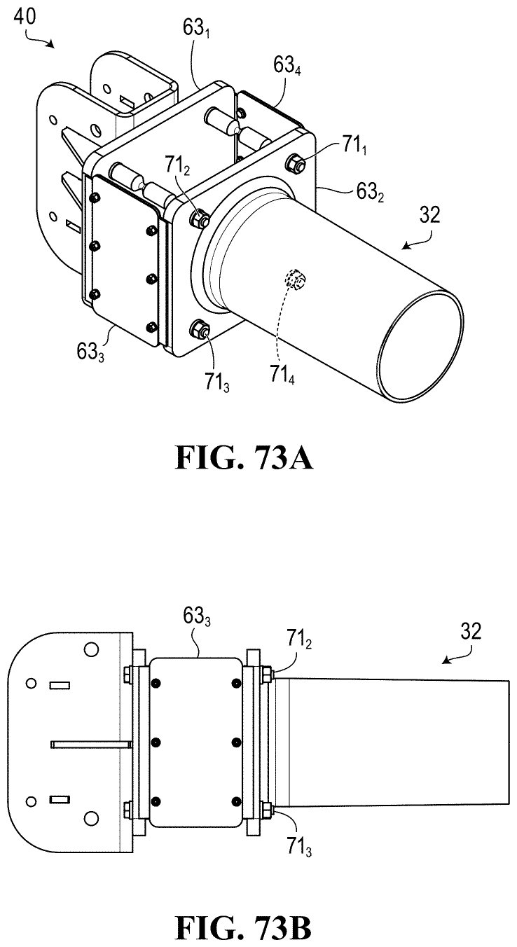

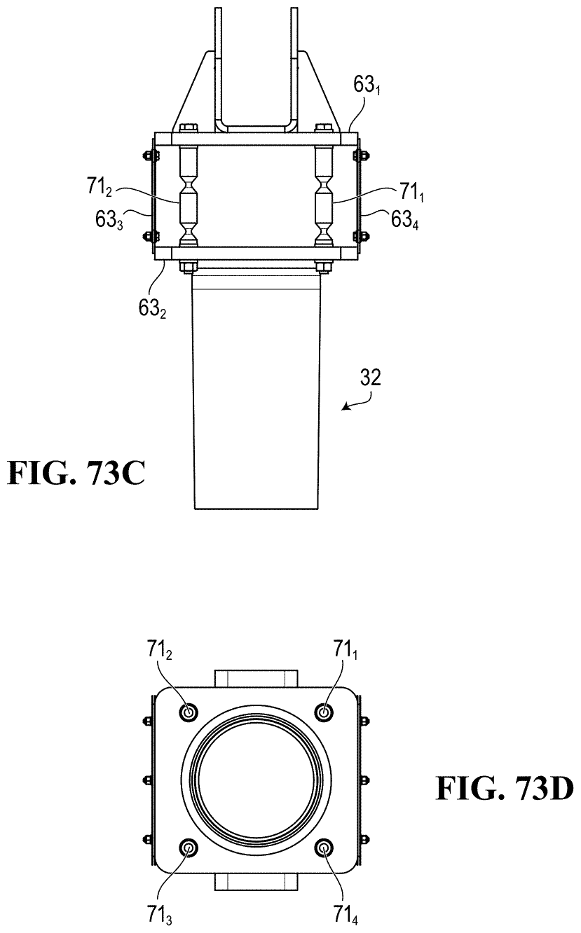

In this embodiment, the arm 20, including its visible arrangement 38, is configured to prevent excessive wind deflection, i.e., deflection of the arm 20, including its visible arrangement 38, due to wind. That is, the arm 20, including its visible arrangement 38, is constructed such that it does not excessively deflect due to wind that can be encountered normally at the roadway 12. For example, in some embodiments, as shown in FIGS. 7A and 73, a deflection 8 of the arm 20, and thus of its visible arrangement 38, (measured based on a free longitudinal edge 66 of the arm 20, which in this case is part of the visible arrangement 38, relative to a vertical direction about a horizontal axis when there is no wind) at a wind speed of 100 km/h may be no more than 15°, in some cases no more than 10°, in some cases no more than 5°, and in some cases even less (e.g., 0°, i.e., zero deflection such that the visible arrangement 38 stays exactly in place). As another example, in some embodiments, as shown in FIG. 6, a deflection 13 of the arm 20, and thus of its visible arrangement 38, (measured based on a distal end 13 of the arm 20, about a vertical axis when there is no wind) at a wind speed of 100 km/h may be no more than 15°, in some cases no more than 10°, in some cases no more than 5°, and in some cases even less (e.g., 0°, i.e., zero deflection such that the arm 20 stays exactly in place).

The control system 30 is configured to support and move the arm 20 between its extended position and its retracted position in order to selectively close and leave open the lanes 14₁, 14₂. In this embodiment, the control system 30 is configured such that the arm 20 is movable horizontally relative to the control system 30 between its extended position and its retracted position.

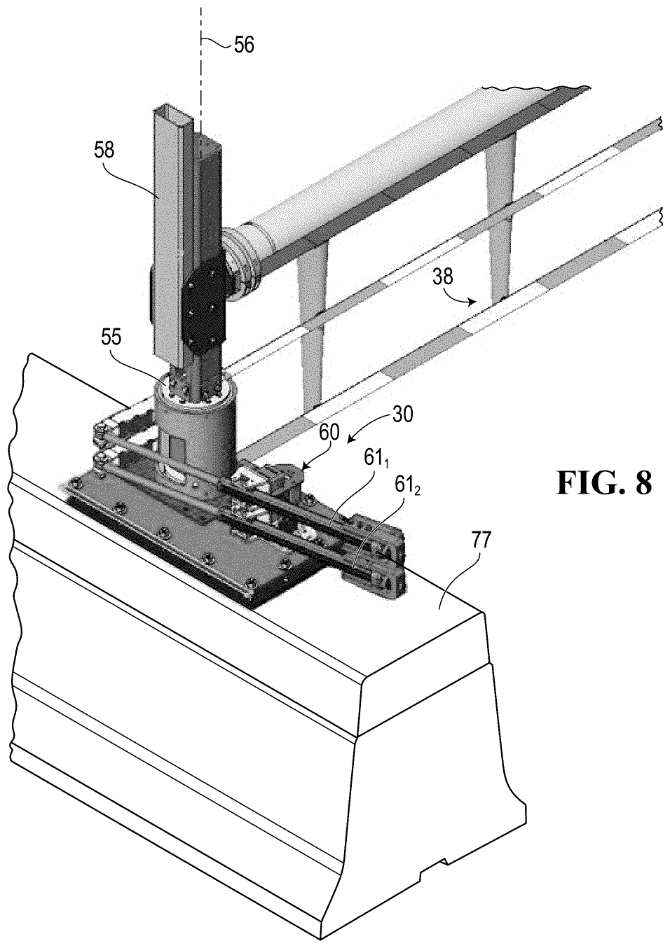

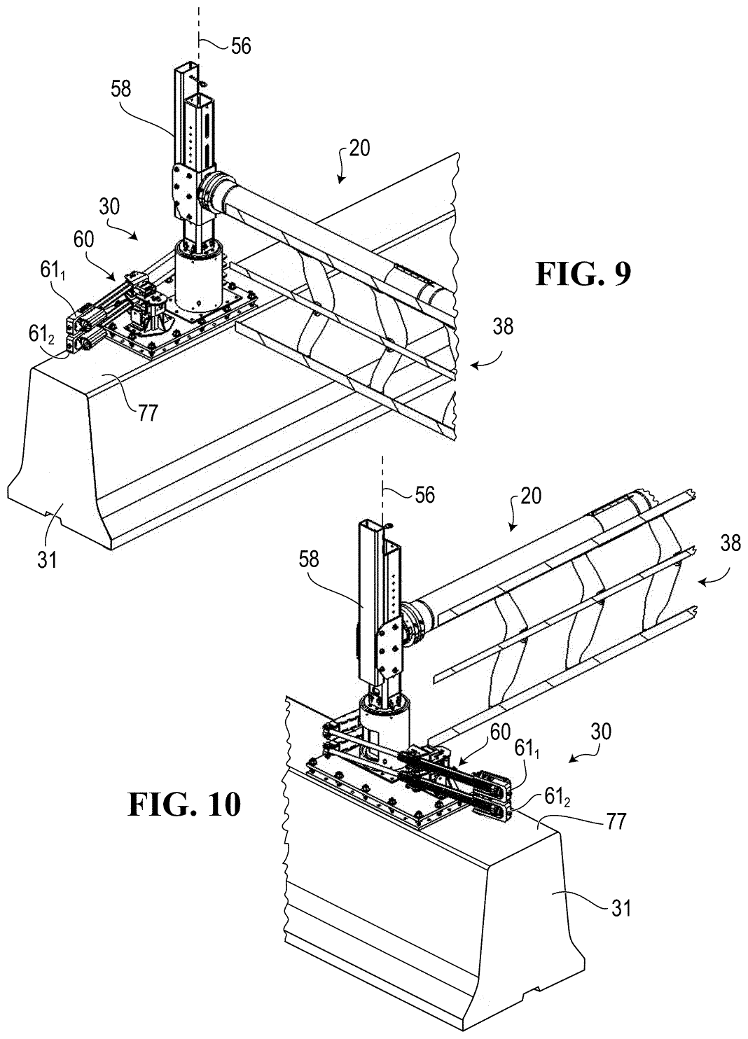

With additional reference to FIGS. 5 and 8 to 10, the control system 30 comprises an actuator 60 for moving the arm 20 between its extended position and its retracted position. In this embodiment, the actuator 60 is configured to cause pivoting of the arm 20 between its extended position and its retracted position about a pivot 55 having a pivot axis 56. In this example, the control system 30 comprises a support 58 carrying the arm 20 and implementing the pivot 55. Upon actuation by the actuator 60, the arm 20 is pivotable about the pivot 55 between its extended position and its retracted position.

In this embodiment, the actuator 60 comprises a linear actuator. More particularly, in this embodiment, the actuator 60 comprises an electromechanical linear actuator. In this example, the actuator 60 comprises a plurality of linear actuating members 61₁, 61₂ that are operative to pivot the arm 20 about the pivot axis 56. In other embodiments, the actuator 60 may be implemented in any other suitable way. For instance, in other embodiments, the actuator 60 may comprise a fluidic actuator, such as a hydraulic or pneumatic actuator, or may comprise a motor, such as an electric motor, or other rotary actuator.

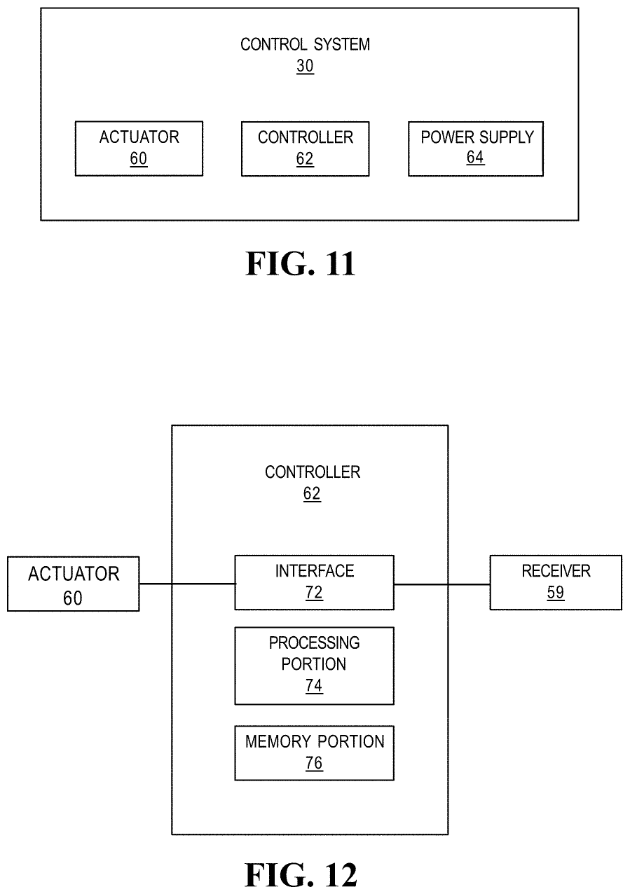

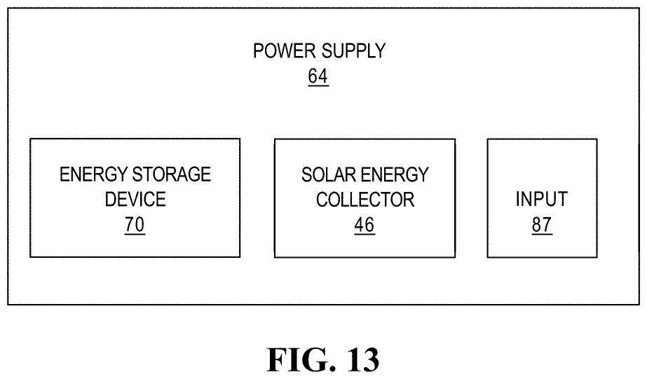

More particularly, in this embodiment, referring additionally to FIGS. 11, 12 and 13, the control system 30 comprises a power supply 64 for providing power to the gate 10 and a controller 62 for controlling operation of the actuator 60 in order to automatically move the arm 20 between its extended position and its retracted position.

In this embodiment, the power supply 64 comprises an input 87 electrically connectable to a power grid to be electrically powered by the power grid for operation of the gate 10, including the actuator 60 and the controller 62 of the control system 30. Also, in this embodiment, the power supply 64 comprises an energy storage device 70 that stores energy for operation of the gate 10 (e.g., in case of a failure or other problem precluding power to be received from the power grid). In this example, the energy storage device 70 comprises a battery. Also, in some cases, the control system 30 may be solar-powered in that the energy storage device 70 may store energy derived from sunlight. The power supply 64 may thus comprise a solar energy collector 46 to collect the sunlight and convert it into electrical energy stored in the energy storage device 70. For instance, the solar energy collector 46 may comprise a solar panel that may comprise a plurality of photovoltaic cells. In other examples, the energy storage device 70 may be implemented in any other suitable way (e.g., comprise a capacitor instead of or in addition to a battery). In other embodiments, the control system 30 may be powered in any other suitable manner (e.g., by being solely electrically connected to the power grid without having the energy storage device 70, or by being solely powered by the energy storage device 70 without being connected to the power grid).

The controller 62 comprises suitable hardware and/or software implementing an interface 72, a processing portion 74, and a memory portion 76 to control operation of the gate 10.

The interface 72 comprises one or more inputs and outputs allowing the controller 62 to receive input signals from and send output signals to other components to which the controller 62 is connected (i.e., directly or indirectly connected). For example, in some embodiments, an input of the interface 72 may be implemented by a receiver 59 of the control system 30 to receive a signal from a remote location (e.g., a traffic management center, a remote control device) to move the arm 20 in order to close or open the lanes 141, 142. In some embodiments, the receiver 59 may be configured to wirelessly receive the signal over a wireless link (e.g., implemented by an industrial, scientific and medical (ISM) radio band, radio frequency waves (RF), a cellular network, a wireless local area network (WLAN), etc.). In other embodiments, the receiver 59 may be configured to receive the signal over a wire (e.g., cable). An output of the interface 72 may be implemented by a transmitter to transmit a signal to the actuator 60.

The processing portion 74 comprises one or more processors for performing processing operations that implement functionality of the controller 62. A processor of the processing portion 74 may be a general-purpose processor executing program code stored in the memory portion 76. Alternatively, a processor of the processing portion 74 may be a specific-purpose processor comprising one or more preprogrammed hardware or firmware elements (e.g., application-specific integrated circuits (ASICs), electrically erasable programmable read-only memories (EEPROMs), etc.) or other related elements.

The memory portion 76 comprises one or more memories for storing program code executed by the processing portion 74 and/or data used during operation of the processing portion 74. A memory of the memory portion 76 may be a semiconductor medium (including, e.g., a solid-state memory), a magnetic storage medium, an optical storage medium, and/or any other suitable type of memory. A memory of the memory portion 76 may be read-only memory (ROM) and/or random-access memory (RAM), for example.

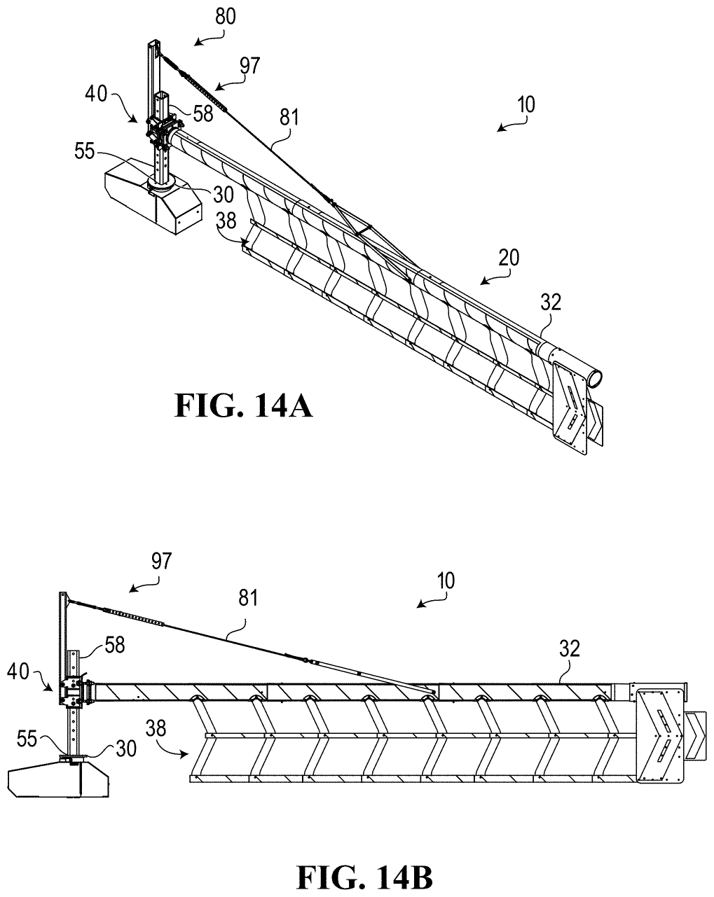

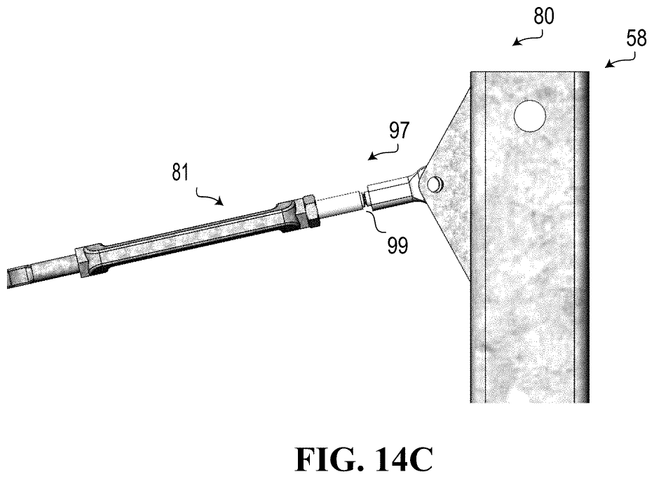

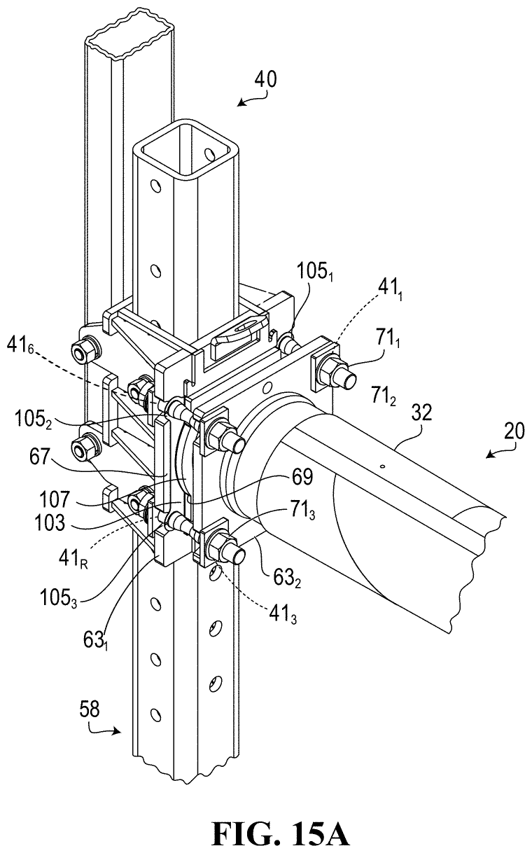

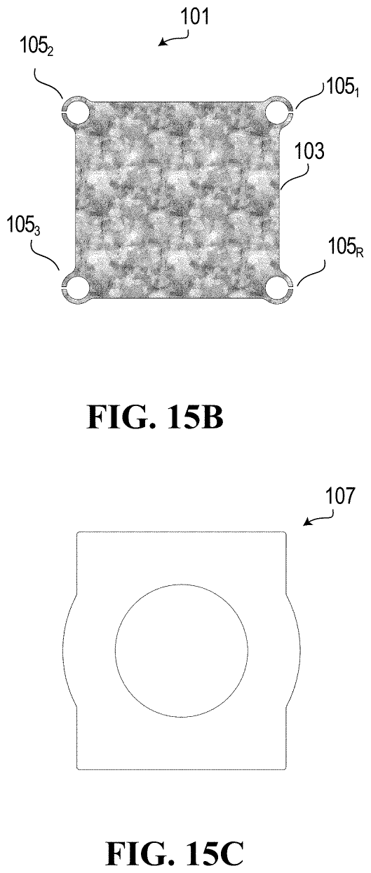

In this embodiment, as shown in FIGS. 14A, 14B and 15A, the control system 30 comprises a release mechanism 40 configured to release the arm 20 if the arm 20 is in its extended position and impacted by a vehicle that is relatively large, hereinafter referred to as a “large vehicle”, which is a heavy truck, a bus or other vehicle larger than a pickup truck. This may enhance safety by allowing that large vehicle to continue its course, possibly with the arm 20 as one piece in front of it, while avoiding excessive damage to that large vehicle and avoiding sections of the arm 20 becoming projectiles that could potentially present hazards to other vehicles. Conversely, if the gate 10 is impacted by a smaller vehicle, i.e., no larger than a pickup truck, that smaller vehicle may not hit the arm 20 (i.e., clear the arm 20 by passing under it) or may not generate sufficient force on the release mechanism 40 so that the arm 20 is unreleased by the release mechanism 40 (i.e., remains in its extended position and properly supported by the control system 30).

Thus, in this example of implementation, a large vehicle causing the release mechanism 40 to release the arm 20 when impacting the arm 20 is larger than a pickup truck. For example, in some cases, a height of the large vehicle is greater than a height of a pickup truck complying with MASH crash-testing, For instance, the height of the large vehicle may be greater than 72 inches, in some cases at least 74 inches, in some cases at least 80 inches, and in some cases greater than 80 inches, Additionally or alternatively, in some cases, the large vehicle may be of Class 7 or higher according to the Federal Highway Administration (FHWA) with a gross vehicle weight rating (GVWR) greater than 26,000 pounds (11,793 kg), or in some cases, the large vehicle may be a Tractor/Van Trailer or a Tractor/Tank Trailer, according to MASH test vehicle standards, with a curb mass of 29,000 pounds, ±3,100 pounds (13,200 kg, ±1,400 kg).

In this embodiment, the release mechanism 40 is configured to detach the arm 20 from the control system 30 if the arm 20 is in its extended position and impacted by a large vehicle. Thus, in this example, the arm 20 detaches from the support 58 implementing the pivot 55 and falls toward the surface 17 of the roadway 12.

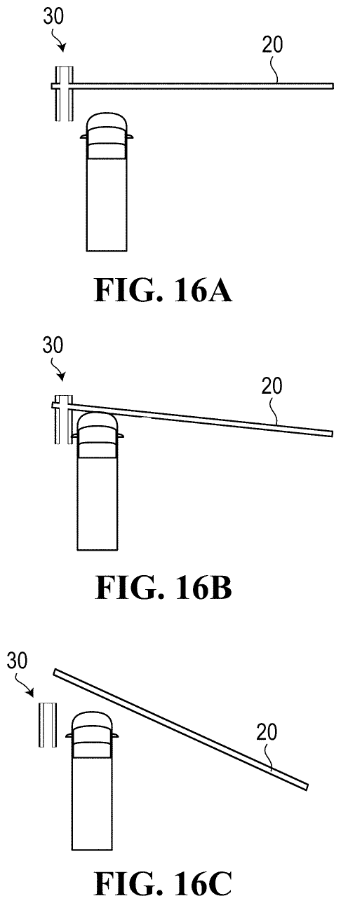

Specifically, the release mechanism 40 is configured to release the arm 20 by detaching the arm 20 from the control system 30. In one example of implementation, the release mechanism 40 is configured to detach the arm 20 from the control system 30 as one piece. In this example, the release mechanism 40 is configured to detach the arm 20 from the control system 30 as one piece in front of the large vehicle, as shown in FIG. 16.

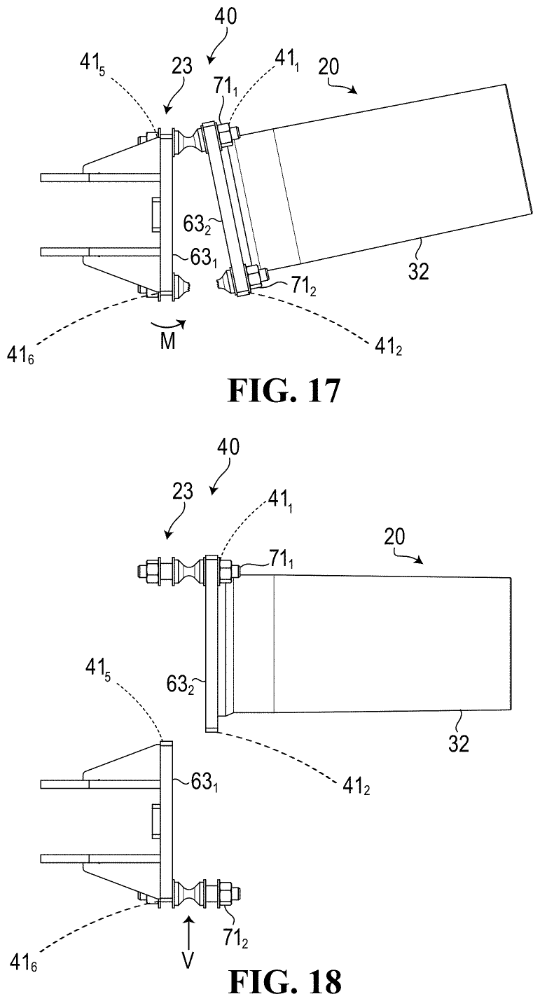

More particularly, in this embodiment, the release mechanism 40 is configured to release the arm 20 (in this case by detaching the arm 20) in any one of a plurality of release modes that are different based on where the arm 20 is impacted by the vehicle. Notably, in this embodiment, the release mechanism 40 is configured such that: a first one of the release modes, which can be referred to as a “flexion-based” release mode, is at least mainly (i.e., mainly or entirely) caused by a bending moment M at the release mechanism 40, as shown in FIG. 17; and a second one of the release modes, which can be referred to as a “shear-based” release mode, is at least mainly (i.e., mainly or entirely) caused by a shear force Vat the release mechanism 40, as shown in FIG. 18.

In this example, the release mechanism 40 is configured to release the arm 20 at least mainly (i.e., mainly or entirely) due to a bending moment at the release mechanism 40 when the arm 20 is impacted by the vehicle at a location L1 and at least mainly (i.e., mainly or entirely) due to a shear force at the release mechanism 40 when the arm 20 is impacted by the vehicle at a location L2 closer to the control system 30 than the location L1.

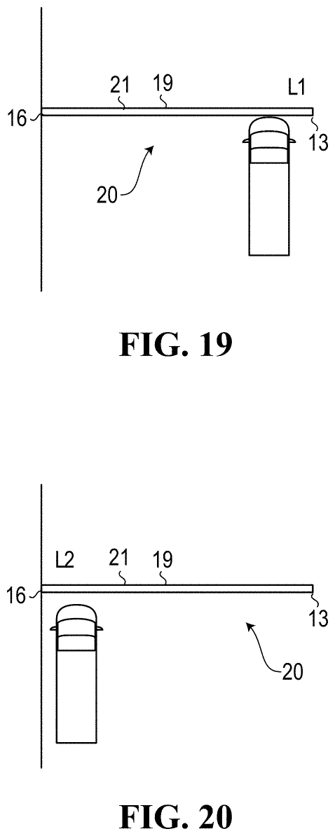

As shown in FIG. 19, in this embodiment, the location L1 may be located between an intermediate point 21 of the arm 20 and a distal end 13 of the arm 20 in the longitudinal direction of the arm 20. As shown in FIG. 20, in this example, the location L2 may be located between the intermediate point 21 of the arm 20 and a proximal end 16 of the arm 20 in the longitudinal direction of the arm 20. The location of the intermediate point 21 may depend on several parameters, including, for example, a ratio of a flexural strength of the release mechanism 40 over a shear strength of the release mechanism 40, a mass of the beam 32 of the arm 20, and/or the speed of the vehicle. For example, in some embodiments, if the vehicle travels at low speed, it may merely push the arm 20. In this example, the intermediate point 21 may be close to the control system 30 and in this example, the mass of the beam 32 may have a negligible influence on the location of intermediate point 21. In the case of the vehicle travelling at high speed, the intermediate point 21 may move towards the distal end 13 of the arm 20 without moving beyond a midpoint 19 of the arm 20.

In this embodiment, the release mechanism 40 is configured such that, in the flexion-based release mode, the bending moment is sufficient to cause the arm 20 to be released but insufficient to impair the control system 30 outside of the release mechanism 40. Similarly, in the shear-based release mode, the shear force is sufficient to cause the arm 20 to be released but insufficient to impair the control system 30 outside of the release mechanism 40.

As shown in FIG. 15A, in this embodiment, the release mechanism 40 comprises a plurality of supporting members 63₁-63s of the support 58. The plurality of supporting members 63₁-63₅ of the support 58 are movable relative to one another to release the arm 20. As such, the release mechanism 40 is configured to release the arm 20 by detaching the arm 20 from the control system 30 and respective ones of the plurality of supporting members 63₁-63ₛ are configured to move relative to one another to detach the arm 20.

In one embodiment, a first one of the plurality of supporting members 63₁-63ₛ is a base 63₁ and a second one of the plurality of supporting members 63₁-63ₛ is an arm carrier 63₂ that carries the arm 20.

In one example of implementation of this embodiment as shown in FIG. 15A, the base 63₁ comprises a planar surface 67 and the arm carrier 63₂ comprises a planar surface 69 facing the planar surface 67 of the base 63₁, the arm carrier 63₂ being spaced from the base 63₁

The arm carrier 63₂ is movable relative to the base 63₁ to release the arm 20. Specifically, the arm carrier 63₂ is configured to be released with the arm 20 when the releasing mechanism 40 releases the arm 20. In this case, the arm carrier 63₂ is configured to be detached from the base 63₁ when the releasing mechanism 40 releases the arm 20. The arm carrier 63₂ is configured to slidingly move relative to the base 63₁ in the second one of the release modes.

As shown in FIGS. 17 and 18, in this embodiment, the release mechanism 40 comprises a connection 23 of the arm carrier 63₂ and the base 63₁. The connection 23 of the arm carrier 63₂ and the base 63₁ is frangible to break in the flexion-based release mode (as shown in FIG. 17) and allows the arm carrier 63₂ to slidingly move relative to the base 63₁ in the shear-based release mode (as shown in FIG. 18).

In this embodiment, the connection 23 of the arm carrier 63₂ and the base 63₁ comprises a plurality of fasteners 71₁-71_{F}. In this example of implementation, the base 63₁ and the arm carrier 63₂ comprise recesses 41₁-41_{R} receiving the fasteners 71₁-71_{F}. Respective ones of the fasteners 71₁-71_{F} are configured to slidingly move out of respective ones of the recesses 41₁-41_{R} to release the arm 20.

A given one of the fasteners 71₁-71_{F}, namely a fastener 71ₓ will be described below with the understanding that such a description may apply to each of the plurality of fasteners 71₁-71_{F}

The fastener 71ₓ is frangible to release the arm 20. The fastener 71ₓ may be configured to be frangible in any suitable fashion (e.g. shape, dimensions, material etc.).

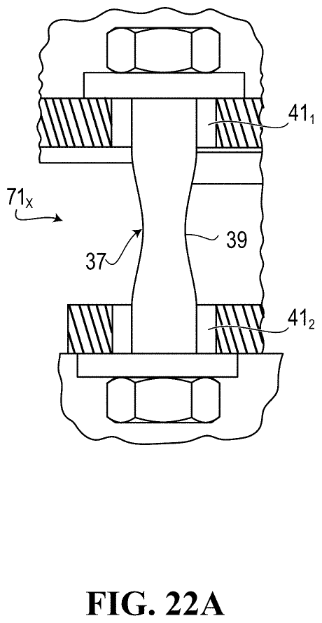

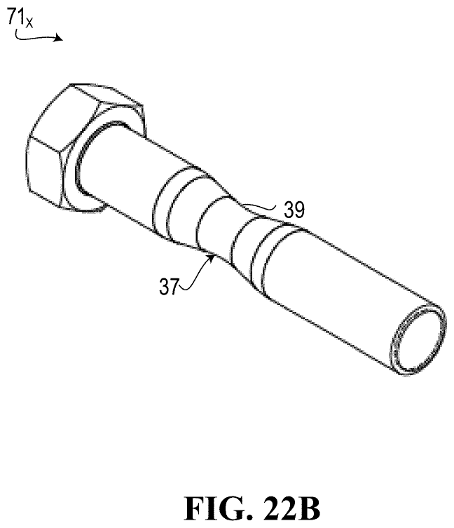

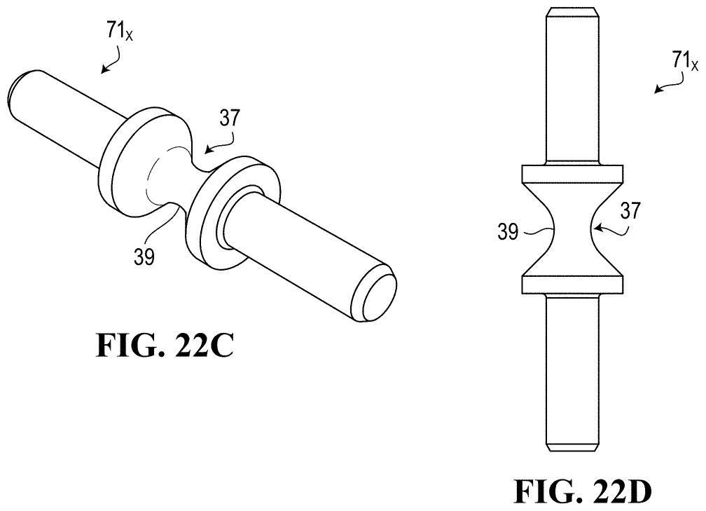

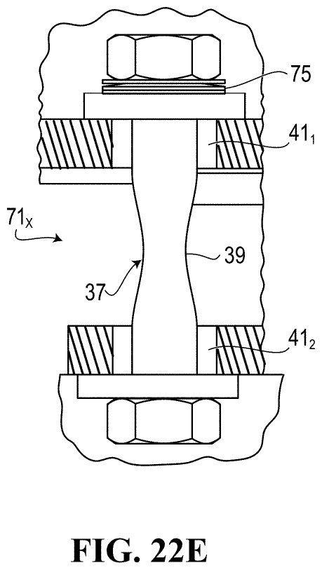

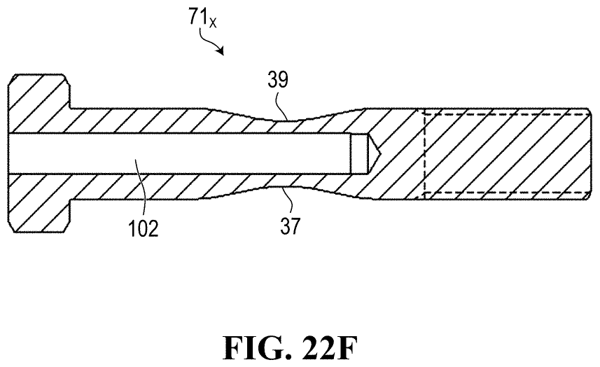

As shown in FIGS. 22A, 22B, 22C, 22D and 22E, in one example of implementation, the fastener 71ₓ may comprise a zone of weakness 37. The zone of weakness 37 may be configured in any suitable manner. For example, in this embodiment, the zone of weakness 37 of the fastener 71ₓ may include a constriction 39.

In one example of implementation, the fastener 71ₓ may be preloaded in tension. Preloading the fastener 71ₓ in tension may help to improve the mechanical resistance in fatigue (e.g. due to wind or other factors leading to loading and unloading cycles of stress), prevent joint separation and loosening from vibration.

For example, the release mechanism 40 may comprise a washer 75 engaging the fastener 71ₓ to preload the fastener 71ₓ in tension, as shown in FIG. 22E. The washer 75 may help prevent the fastener 71ₓ from loosening with time and may help maintain the load on the fastener 71ₓ constant

The washer 75 may be of any suitable type. In one example of implementation, the washer 75 may be a spring washer. In another example of implementation, the washer 75 may be a Belleville washer. In yet another example of implementation, the washer 75 may be a direct tension indicator (DTI) washer.

The fastener 71ₓ may be preloaded in tension in any other suitable way.

In some embodiments, the fastener 71ₓ may be configured to comprise a recess 102, as shown in FIG. 22F. The recess 102 may be located in a center of the fastener 71ₓ. The recess 102 may increase the torsional strength of the fastener 71ₓ during the initial tightening of the fastener 71ₓ by displacing material away from the center of the fastener 71ₓ. Specifically, by displacing material away from the center of the fastener 71ₓ, the value of the second polar moment of area (J) increases which consequently increases the torsional strength of the fastener 71ₓ.

A footprint of the gate 10 on the median barrier 31 to which it is mounted may be relatively small. This may facilitate installation of the gate 10 on existing road infrastructures.

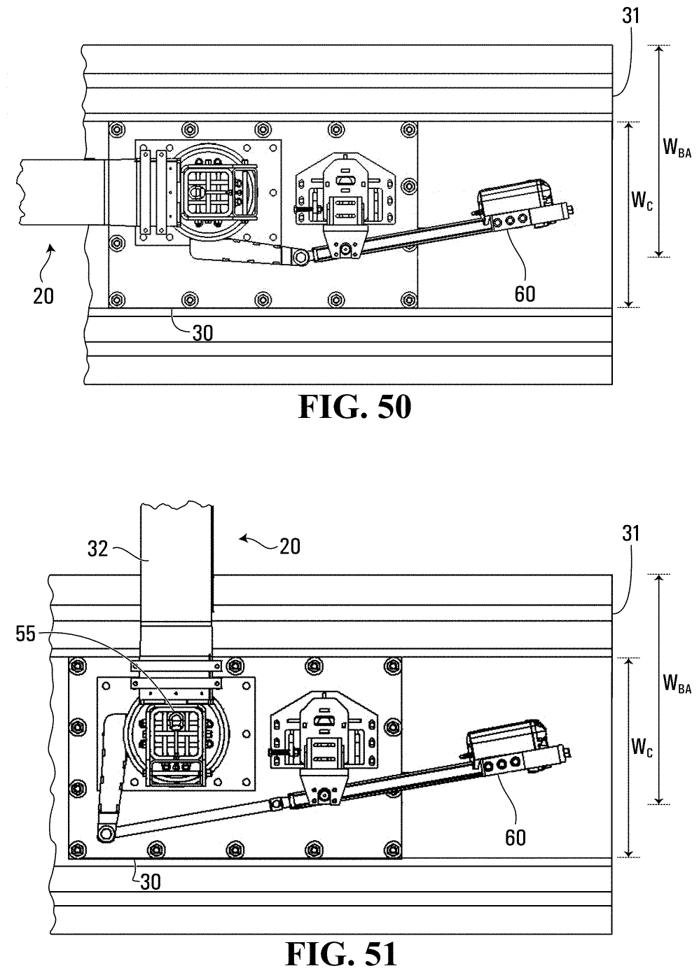

For example as shown in FIGS. 50 and 51, in some embodiments, the footprint of the gate 10 on the median barrier 31 in the longitudinal direction of the arm 20 in its extended position may be no more than 30 inches, in some cases no more than 25 inches, in some cases no more than 20 inches, in some cases no more than 15 inches, in some cases no more than 10 inches, and in some cases even less. For instance, in some examples, the footprint of the gate 10 on the median barrier 31 may be narrower than the median barrier 31 where the control system 30 is mounted, i.e., narrower than a width W_{BA} of the median barrier 31 where the control system 30 is mounted.

To that end, in this embodiment, the control system 30 may be quite compact. For example, in some embodiments, the control system 30 may be narrow in the longitudinal direction of the arm 20 in its extended position. For instance, in some embodiments, a ratio of a dimension We of the control system 30 in the longitudinal direction of the arm 20 in its extended position over the length L_{A} of the arm 20 in its extended position may be no more than 15%, in some cases no more than 10%, in some cases no more than 5%, and in some cases even less.

In some embodiments, a portion of the median barrier 31 to which the control system 30 is mounted may be wider than an adjacent portion of the median barrier 31 that precedes or follows the portion of the median barrier 31 to which the control system 30 is mounted. That is, the width W_{BA} of the median barrier 31 where the control system 30 is located may be smaller than the width W_{BA} of the median barrier 31 where the control system 30 is not located. This may facilitate accommodating the gate 10 while allowing other parts of the median barrier 31 to be narrower.

The gate 10 may facilitate its installation at the roadway 12 and be reusable and easily repairable if crashed into.

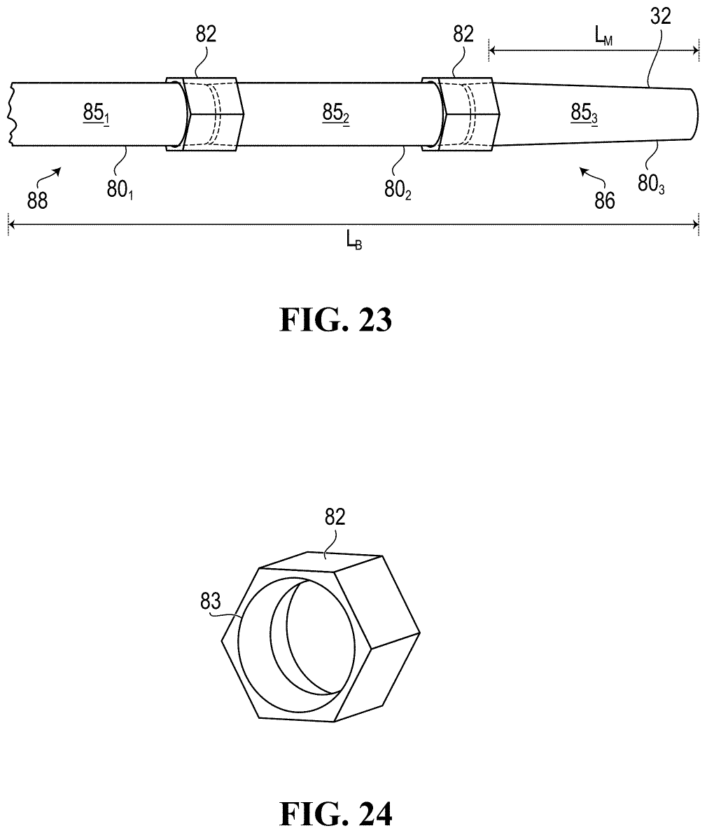

For example, with additional reference to FIG. 23, in some embodiments, the beam 32 may comprise a plurality of beam segments 80₁-80_{M} that are separate and interconnectable for assembling the beam 32. For instance, each of the beam segments 80₁-80_{M} may be sized to facilitate its transportation, handling and assembly into the arm 20 to be installed at the roadway 12. As an example, in some embodiments, a length L_{M} of each of one or more of the beam segments 80₁-80_{M} may be no more than half, in some cases no more than 40%, in some cases no more than 30%, in some cases no more than 20%, and in some cases even a smaller fraction of a length L_{B} of the beam 32.

With reference to FIGS. 23 and 24, adjacent ones of the beam segments 80₁-80_{M} may be interconnected by a connector 82. The connector 82 may be implemented in any suitable way. For example, in some embodiments, the connector 82 may comprise a hollow space 83 (e.g. a circular or other sleeve) configured to slidably engage an end of each of adjacent ones of the beam segments 80₁-80_{M}. A mechanical fastener or an adhesive may then be used to fasten or bond the connector 82 to each of the adjacent ones of the beam segments 80₁-80_{M} (i.e. end-to-end assembly). In other embodiments, the connector 82 may also comprise a clamp (e.g. clamp ring, clamp sleeve, or any other suitable compression attachment device) for receiving and removably securing an end of each of adjacent ones of the beam segments 80₁-80_{M} end-to-end. As such, each of adjacent ones of the beam segments 80₁-80_{M} are compressively secured (i.e., clamped) together. In addition to, or instead of, being compressively secured, the connector 82 may be further secured to each of adjacent ones of the beam segments 80₁-80_{M} by one or more mechanical fasteners (e.g., a bolt, screw, rivet, etc.).

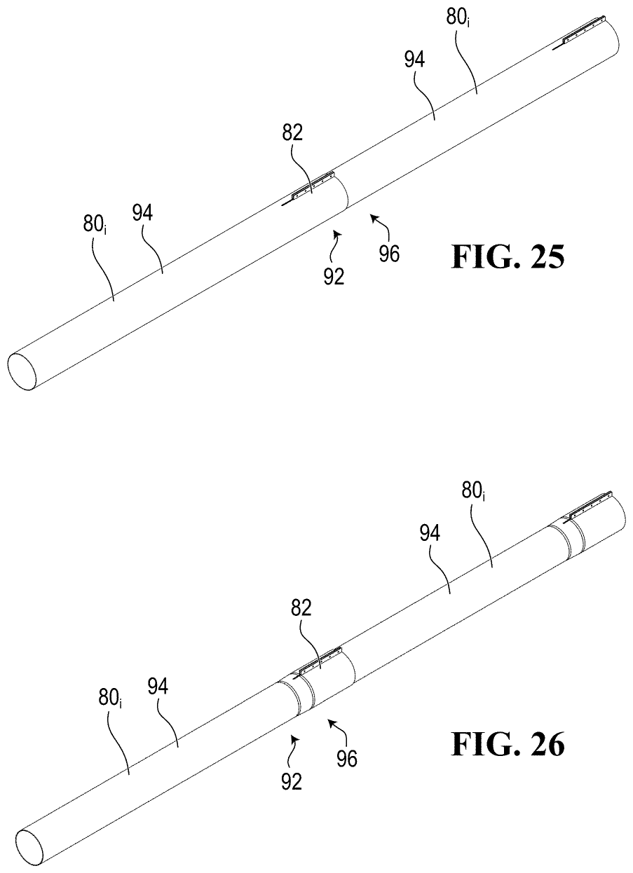

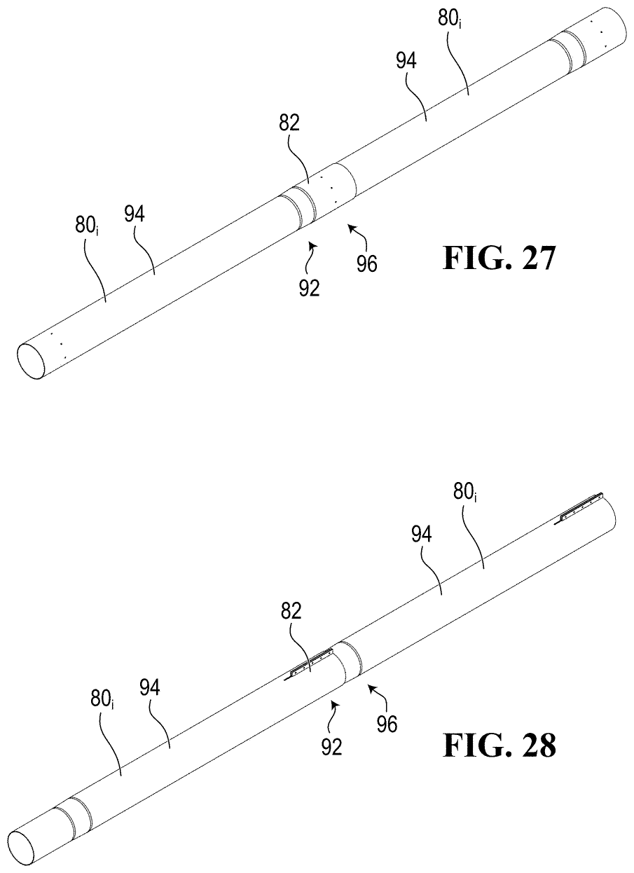

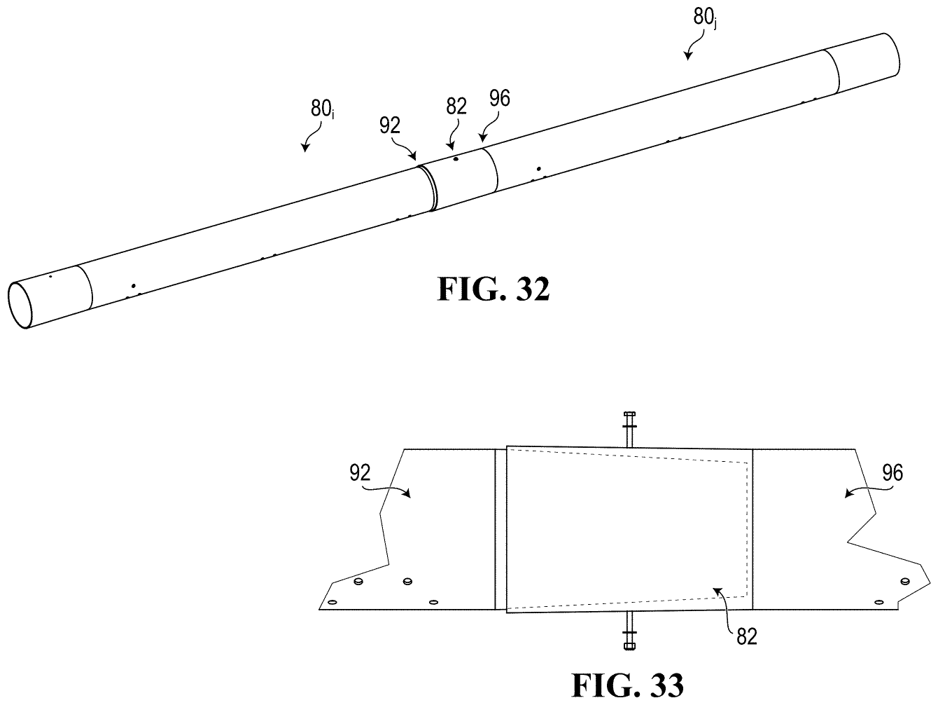

In other embodiments, as shown in FIGS. 25 to 28, the connector 82 for interconnecting adjacent ones of the beam segments 80₁-80_{M} may be integral with the beam segments 80₁-80_{M} (as opposed to be a separate component) and include a dimensional change (e.g., a reduction or expansion) of portions of the beam segments 80₁-80_{M} to secure the adjacent ones of the beam segments 80₁-80_{M} to one another. More particularly, in such cases, the connector 82 for interconnecting adjacent ones of the beam segments 80₁-80_{M} may include an end portion 92 of a beam segment 80ᵢ that has a different (e.g., smaller or larger) cross-section than a longitudinal portion 94 thereof and an end portion 96 of an adjacent beam segment 80ⱼ that is configured to receive (or to be received by) the end portion 92 of the beam segment 80ᵢ. For instance as shown in FIGS. 32 and 33, in some cases, end portions 92, 96 of the adjacent ones of the beam segments 80₁-80_{M} may implement a taper connection (e.g. the end portions 92, 96 may implement a conical male portion and a conical female receiving portion), such that, once engaged together, the interconnected end portions 92, 96 may be firmly secured and relative movement between the interconnected end portions 92, 96 may be prevented (i.e. by friction, compression, or a combination thereof), with or without additional fastening means such as mechanical fasteners or adhesives. This type of interconnection may help to improve the mechanical resistance in fatigue of the connector 82 and/or reduce wears at the connector 82 over time and/or facilitate alignment of the end portions 92, 96 during their mutual engagement (as compared with end to end connection without taper, for instance). Additionally or alternatively, such as shown in FIGS. 25, 26 and 28, the end portion 92 may implement a damping device (e.g. damp ring, clamp sleeve, or other suitable compression attachment device) for receiving the end portion 96 of the adjacent beam segment 80j and compressively removably securing (i.e. damping) the end portions 92, 96 together once the damping device is tightened (e.g. by tightening the damping device, or screws of the clamping device). Alternatively or additionally, as shown in FIG. 27, the end portions 92, 96 implementing the connector 82 may comprise one or more mechanical fasteners (e.g., a bolt, screw, rivet, etc.) to fasten the end portions 92, 96 of adjacent beam segments 80₁-80_{M}.

The beam 32 that is segmented and assembled with the connectors 82 to interconnect the beam segments 80₁-80_{M} as discussed above may facilitate transport for assembly at the roadway 12 and allows disassembly and repair of damaged ones of the beam segments 80₁-80_{M} after a car or other vehicle has crashed into the gate 10, efficiently and without impacting a mechanical structure of undamaged ones of the beam segments 80₁-80_{M}.

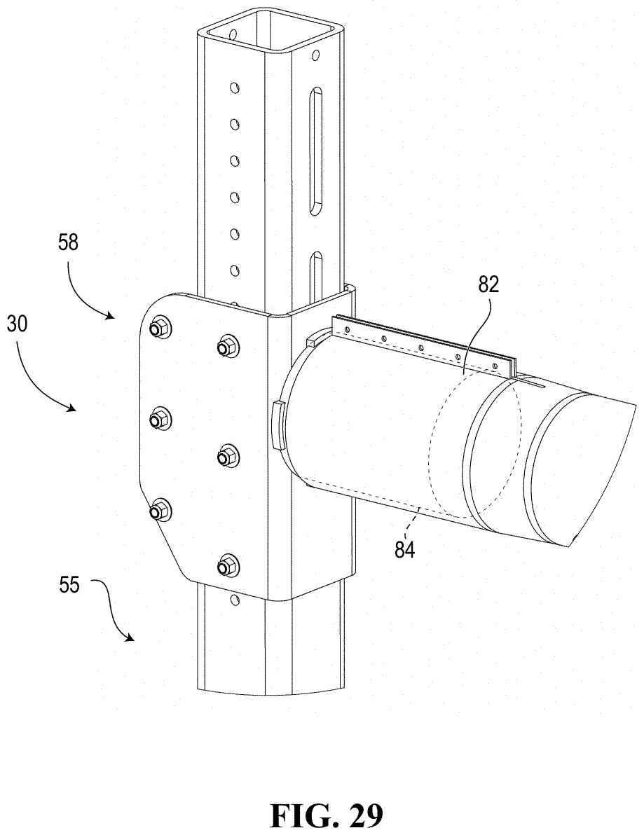

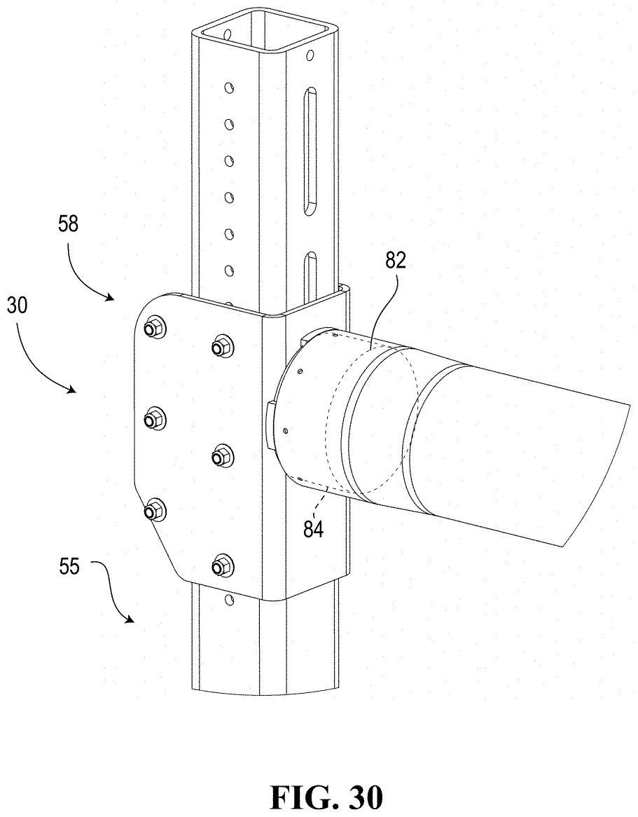

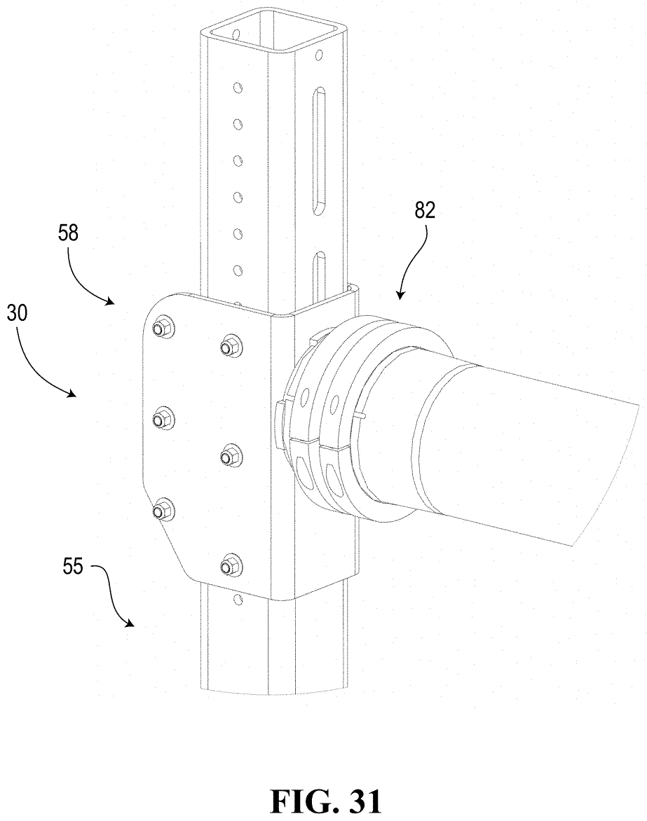

In some embodiments, the beam 32 may be carried by and connected to the support 58 of the control system 30 of the gate 10 similarly as discussed above with respect to the embodiments of the connector 82 for interconnecting adjacent ones of the beam segments 80₁-80_{M}. For instance, as shown in FIGS. 29 to 31, a connector 82, integral with a beam segment 80ᵢ or as a separate part, can be configured to interconnect with the support 58 of the control system 30. The interconnection between the connector 82 and the support 58 can be implemented in many ways. For instance, the support 58 may include a beam-receiving section 84 (e.g., male or female receiving section) for engaging with the connector 82. The connector 82 can then be secured to the beam-receiving section 84 similarly as discussed above with respect to the embodiments of the connector 82 for interconnecting adjacent ones of the beam segments 80₁-80_{M}, including by implementing a taper connection as discussed above.

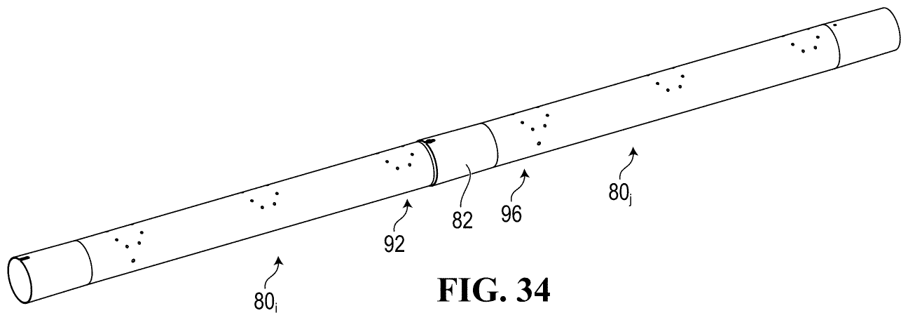

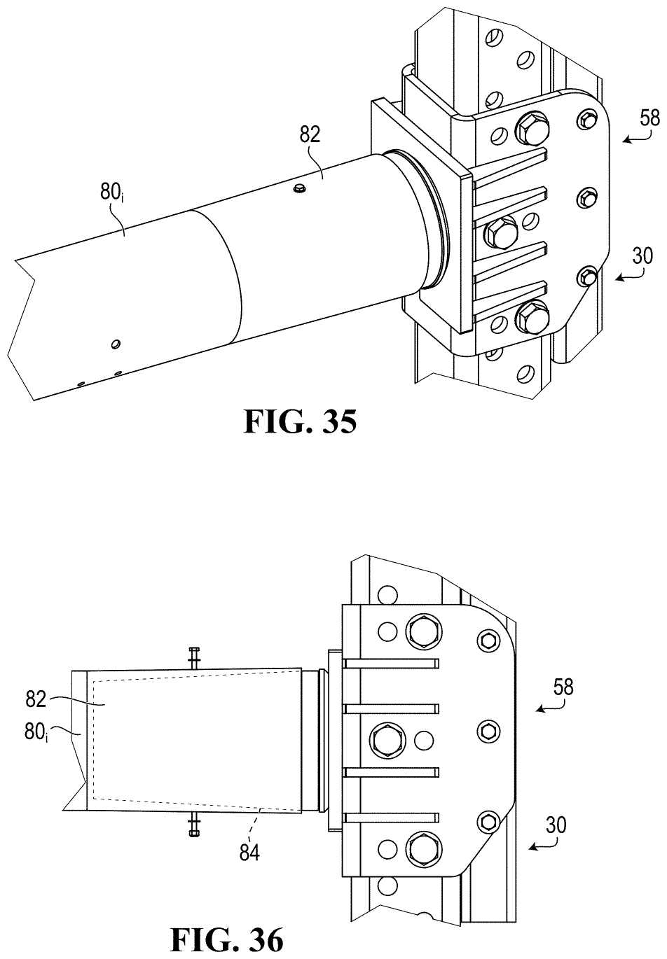

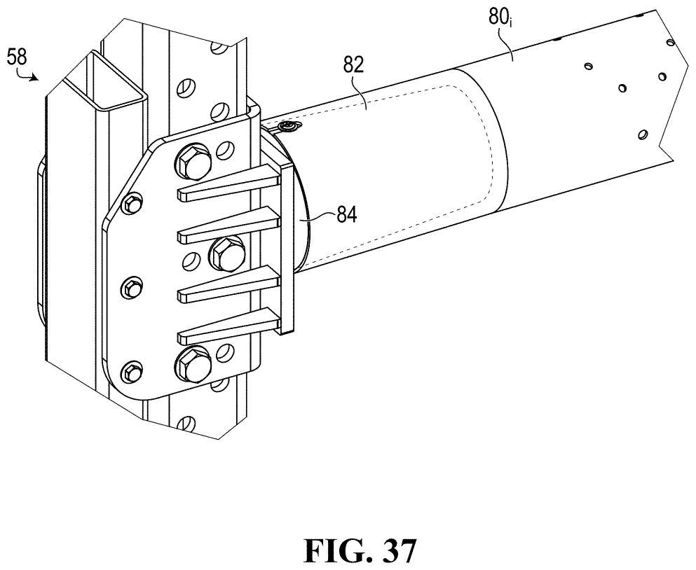

FIGS. 32 to 37 show other embodiments of connectors 82 interconnecting adjacent ones of the beam segments 80₁-80_{M} and/or the support 58. More particularly, as shown in FIGS. 32 and 33, in some embodiments, the connector 82 may be integral with the end portion 96 of the beam segment 80ⱼ and is configured to receive the end portion 92 of the adjacent beam segment 80ᵢ. In this case, the connector 82 implements a taper connection (e.g. conical male portion and a conical female receiving portion) that firmly secures adjacent ones of the beam segments 80₁-80_{M}, and prevents relative movement between the interconnected end portions 92, 96 (i.e. by friction, compression, or a combination thereof), as discussed above in more details. Also, in this case, the connector 82 further includes a mechanical fastener extending therethrough to further secure the connection between end portions 92, 96 of the adjacent ones of the beam segments 80₁-80_{M}, FIG. 34 shows another example of the connector 82. In this case, the connector 82, which is integral with the end portion 96 of the beam segment 80ⱼ, also implements a taper connection, as discussed above with respect to previously discussed embodiments, and further includes a void (e.g. a slot) configured to slidably engage with a mechanical fastener (e.g., a bolt) fastenable to the end portion 92 (e.g., to a rivet nut fixed to the end portion 92). Once tightened, the mechanical fastener inserted into the void and fastened to the end portion 92 further secures the connection between the end portions 92, 96 of the adjacent ones of the beam segments 80₁-80_{M}. FIGS. 35 and 36 show another example of interconnection between the connector 82 and the support 58 using a similar configuration of connector 82 as discussed above and with reference to FIGS. 32 and 33. In this case, the support 58 has a beam-receiving section 84 (as discussed above with respect to another embodiment) that interconnects with the connector 82 and implement a taper connection therebetween, and a mechanical fastener extending through the connector 82 and the beam-receiving section 84 further secures the connection therebetween. FIG. 37 shows another example of interconnection between the connector 82 and the support 58 using a similar configuration of connector 82 as discussed above and with reference to FIG. 34. In this case, the connector 82 also implements a taper connection, as discussed above with respect to previously discussed embodiments, and further includes a void (e.g. slot) configured to slidably engage with a mechanical fastener (e.g. a bolt) fastenable to the beam-receiving section 84 (e.g. to a rivet nut fixed to the beam receiving section 84). Once tightened, the mechanical fastener inserted into the void and fastened to the beam-receiving section 84 further secures the connection between the connector 82 and the support 58.

If an oncoming vehicle (e.g., a passenger car or pickup truck) crashes into the gate 10, while it may be desired that the visible arrangement 38 would deflect without breaking, at least part of the visible arrangement 38 which may be broken by the oncoming vehicle may be replaceable. For example, in some embodiments, in such situations, the arm 20 may be cleared of any damaged (e.g., broken, torn, shredded, etc.) part of the visible arrangement 38, such as one or more of the visible members 33₁, 33₂, 34₁-34_{N}, which can be replaced by replacement of visible members that may be fastened, bonded or otherwise affixed to the beam 32 and/or one another with one or more mechanical fasteners, an adhesive and/or other affixing techniques.

The gate 10, including the arm 20 and the control system 30, may be implemented in various other ways in other embodiments.

For example, in some embodiments, the release mechanism 40 may be implemented in any other suitable manner.

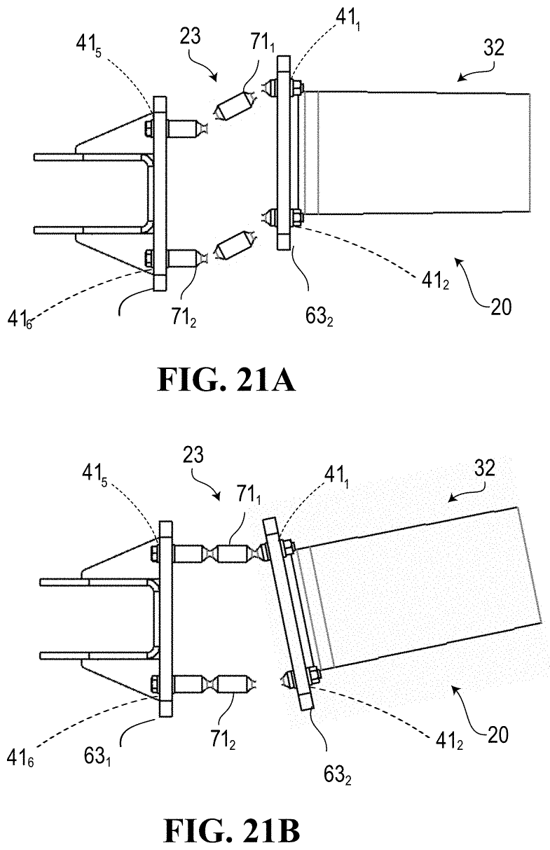

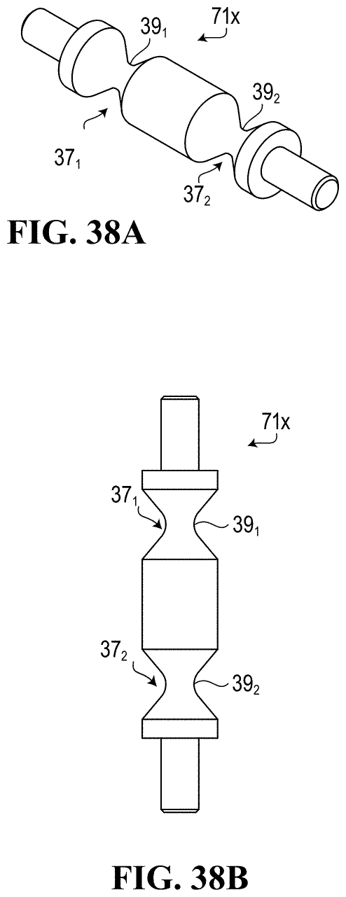

As shown in FIGS. 21A, 21B, 38A and 38B, in some embodiments, the zone of weakness 37 of the fastener 71ₓ is a first zone of weakness 37₁ and the fastener 71ₓ comprises a second zone of weakness 37₂ spaced from the first zone of weakness 37₁. The first zone of weakness 37₁ of the fastener 71ₓ may be a first constriction 39₁ of the fastener 71ₓ and the second zone of weakness 37₂ of the fastener 71ₓ may be a second constriction 39₂ of the fastener 71ₓ.

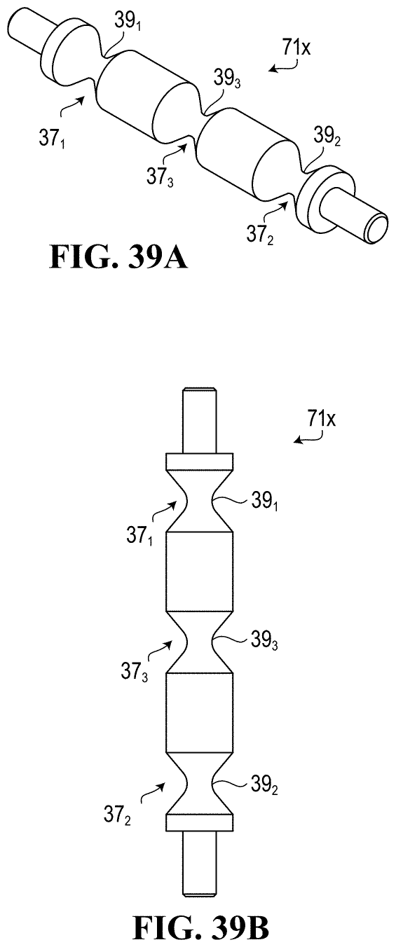

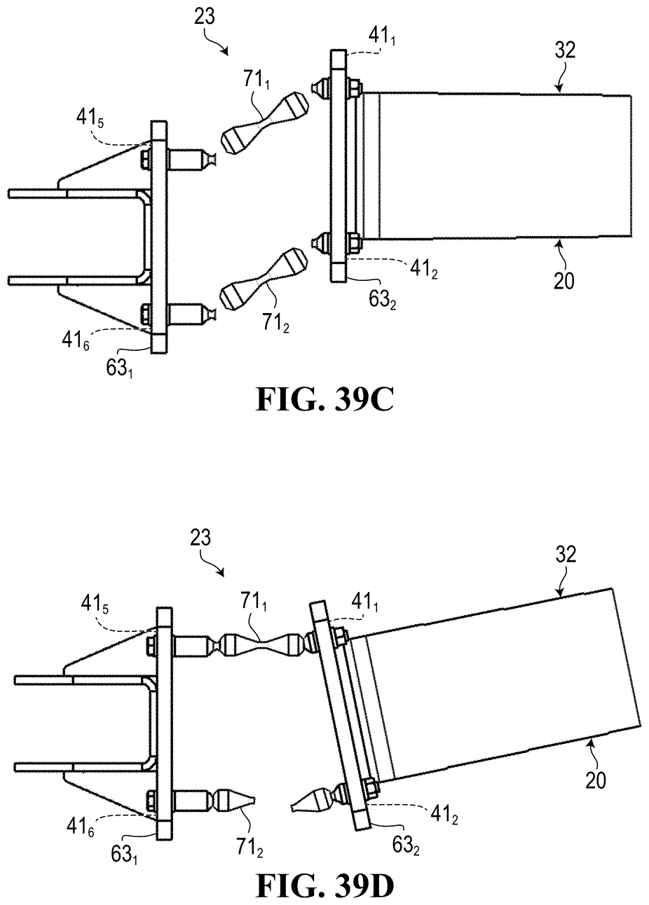

In another embodiment, as shown in FIGS. 39A, 39B, 39C and 39D the fastener 71ₓ may comprise a third zone of weakness 37₃ spaced from the first zone of weakness 37₁ and the second zone of weakness 37₂ of the fastener 71ₓ, where the third zone of weakness 37₃ of the fastener 71ₓ may be a third constriction 39₃ of the fasteners 71ₓ.

In one example of implementation of the above embodiment, the first zone of weakness 37₁, the second zone of weakness 37₂ and the third zone of weakness 37₃ of the fastener 71ₓ are configured to buckle the fastener 71ₓ when the release mechanism 40 releases the arm 20.

In yet another example of implementation of the above embodiment, the fastener 71ₓ may be configured to be frangible to break in a particular location of the fastener 71x depending on if a maximum bending moment is applied to arm 20 or if a maximum shear force is applied to the arm 20. For example, as shown in FIG. 39D, if a maximum bending moment is applied to the arm 20 such that the arm 20 detaches from the support 58 in the flexion-based release mode, the fastener 71ₓ is configured to be frangible to break in tension in a location generally corresponding to the third zone of weakness 37₃ (i.e., the third constriction 39₃) of the fastener 71ₓ thus breaking the connection 23 of the arm carrier 63₂ and the base 63₁. On the other hand, as shown in FIG. 39C, if a maximum shear force is applied to the arm 20 such that the arm 20 detaches from the support 58 in the shear-based release mode, the fastener 71ₓ is configured to be frangible to break in flexion in locations generally corresponding to the first and second zones of weakness 37₁, 37₂, (i.e., the first and the second constrictions 39₁, 39₂) allowing the arm carrier 63₂ to slidingly move relative to the base 63₁, thus breaking the connection 23 of the arm carrier 63₂ and the base 63₁. Accordingly, in some cases, the arm 20 may detach from the support 58 while portions of respective ones of the fasteners 71₁-71_{F} remain in respective ones of the recesses 41₁-41_{R}.

In this example of implementation, the fastener 71ₓ is configured to be frangible to break in a particular location of the fastener 71ₓ as described above due to a shape of the fastener 71ₓ and/or a dimension of the fastener 71ₓ including a shape and/or dimensions of the zones of weakness 37₁, 37₂, 37₃ (i.e., a shape and/or a dimension of the constrictions 39₁, 39₂, 39₃) as will be described below. Additionally, the shape of the fastener 71ₓ and/or a dimension of the fastener 71ₓ including a shape and/or dimensions of the zones of weakness 37₁, 37₂, 37₃ (i.e., a shape and/or a dimension of the constrictions 39₁, 39₂, 39₃) may reduce the possibility of fatigue failure of the fastener 71ₓ (by improving fatigue resistance of the fastener 71ₓ) and may facilitate detachment of the arm 20 from the support 58.

For example, dimensions of the zones of weakness 37₁, 37₂, 37₃ (i.e., the constrictions 39₁, 39₂, 39₃) of the fastener 71ₓ may be chosen such that the fatigue resistance of the fastener 71ₓ may be improved. For instance, the first and the second zones of weakness 37₁, 37₂, (i.e., the first and second constrictions 39₁, 39₂) of the fastener 71ₓ may be configured to comprise a larger dimension (e.g., a larger cross-sectional area, width, diameter, or radius) than other portions of the fastener 71ₓ (for example, a larger dimension than the third zone of weakness 37₃ (i.e., the third constriction 39₃) of the fastener 71ₓ) such that the fatigue resistance of the fastener 71ₓ may be improved. Additionally or alternatively, a curvature or an angle of the third zone of weakness 37₃ (i.e., the third constriction 39₃) of the fastener 71ₓ may be configured to be less acute (e.g., less sharp/comprise a larger radius of curvature) than other portions of the fastener 71ₓ such that the fatigue resistance of the fastener 71x may be improved.

Moreover, dimensions of the zones of weakness 37₁, 37₂, 37₃ (i.e., the constrictions 39₁, 39₂, 39₃) of the fastener 71ₓ may be chosen to facilitate detachment of the arm 20 from the support 58. In one example, the third zone of weakness 37₃ (i.e., the third constriction 39₃) of the fastener 71ₓ may be configured to comprise a smaller dimension (e.g., a smaller cross-sectional area, width, diameter, or radius) than other portions of the fastener 71ₓ (for example, a smaller dimension than the first and the second zones of weakness 37₁, 37₂ (i.e., the first and second constrictions 39₁, 39₂) of the fastener 71ₓ) to facilitate detachment of the arm 20 from the support 58 in the flexion-based release mode. Additionally or alternatively, a curvature or an angle of the first and the second zones of weakness 37₁, 37₂, (i.e., the first and the second constrictions 39₁, 39₂) of the fastener 71ₓ may be configured to be more acute (e.g., sharper comprise a smaller radius of curvature) than other portions of the fastener 71ₓ to facilitate detachment of the arm 20 from the support 58 in the shear-based release mode.

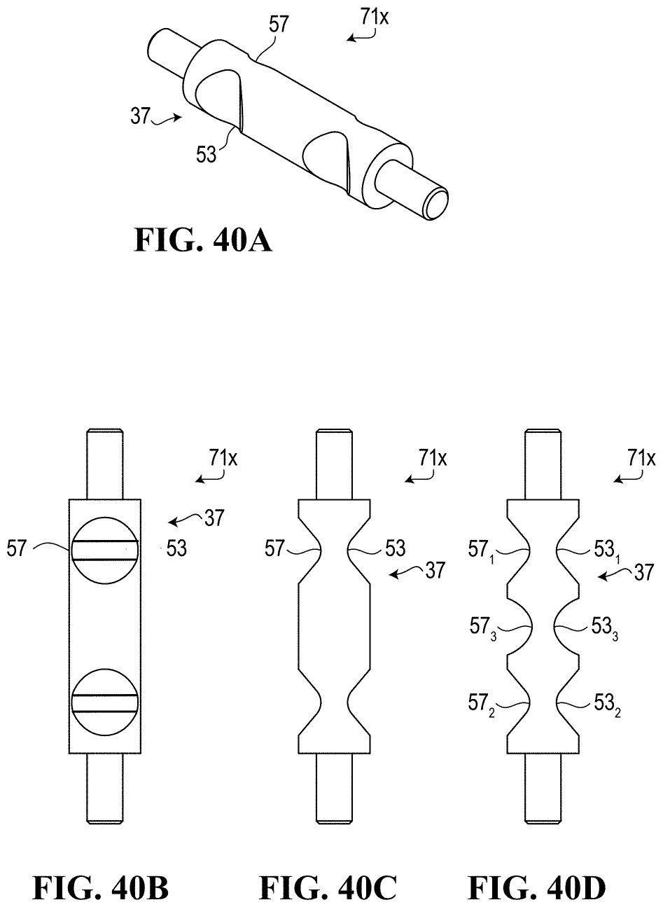

In another example of implementation, as shown in FIGS. 40A, 40B,40C and 40D, the zone of weakness 37 of the fastener 71ₓ is a zone of directional weakness 53 of the fastener 71ₓ where the zone of weakness 37 of the fastener 71ₓ includes a constriction 57 of the fastener 71ₓ in only a single direction. In some cases, the fastener 71ₓ may include a single zone of directional weakness 53 which may be a constriction 57 of the fastener 71ₓ. In other cases, the fastener 71ₓ may comprise a first zone of directional weakness 53₁ spaced from a second zone of directional weakness 53₂. The first zone of directional weakness 53₁ may be a first constriction 57₁ of the fastener 71ₓ and the second zone of directional weakness 53₂ may be a second constriction 57₂ of the fastener 71ₓ. In yet other cases, the fastener 71ₓ may comprise a third zone of directional weakness and 53₃ spaced from the first zone of directional weakness 53₁ and the second zone of directional weakness 53₂. The third zone of directional weakness 53₁ may be a constriction 57₃ of the fastener 71ₓ.

In one example of implementation of the above embodiment, the first zone of directional weakness 53₁, the second zone of directional weakness 53₂ and the third zone of directional weakness 53₃ of the fastener 71ₓ are configured to buckle the fastener 71ₓ when the release mechanism 40 releases the arm 20.

In another example of implementation of the above embodiment, the fastener 71x may be configured to be frangible to break in a particular location of the fastener 71ₓ depending on if a maximum bending moment is applied to arm 20 or a maximum shear force is applied to the arm 20, as described above. Additionally, the first, the second and the third zone of directional weakness 53₁, 53₂ and 53₃ (i.e., the first, the second and the third constriction 57₁, 57₂, 57₃) may also be configured to reduce the possibility of fatigue failure of the fastener 71ₓ (by improving fatigue resistance of the fastener 71ₓ), to facilitate the detachment of the arm 20 from the support 58 as described above.

In various embodiments, the fastener 71ₓ may comprise any suitable material, dimension or configuration.

For example, a material of the fastener 71ₓ and/or a dimension of the fastener 71ₓ may be chosen such that the fastener 71ₓ may tend to fail in shear or bending rather than failing in torsion.

A distance between the first zone of weakness 37₁ and the second zone of weakness 37₂ may be chosen such that if a maximum bending moment is applied to the fastener 71ₓ, the arm 20 is configured to detach from the support 58 of the control system 30 in the flexion-based release mode and if a maximum shear force is applied to the fastener 71ₓ, the arm 20 is configured to detach from the support 58 of the control system 30 in the shear-based release mode.

Similarly, a dimension of the zone of weakness 37 may be chosen such that if a maximum bending moment is applied to the fastener 71ₓ, the arm 20 is configured to detach from the support 58 of the control system 30 in the flexion-based release mode and if a maximum shear force is applied to the fastener 71ₓ, the arm 20 is configured to detach from the support 58 of the control system 30 in the shear-based release mode.

The connection 23 of the release mechanism 40 may comprise any suitable number of fasteners such as the fastener 71ₓ. For example, in one embodiment, three fasteners such as the fastener 71ₓ may be provided. In yet another embodiment, four fasteners such as the fastener 71ₓ may be provided.

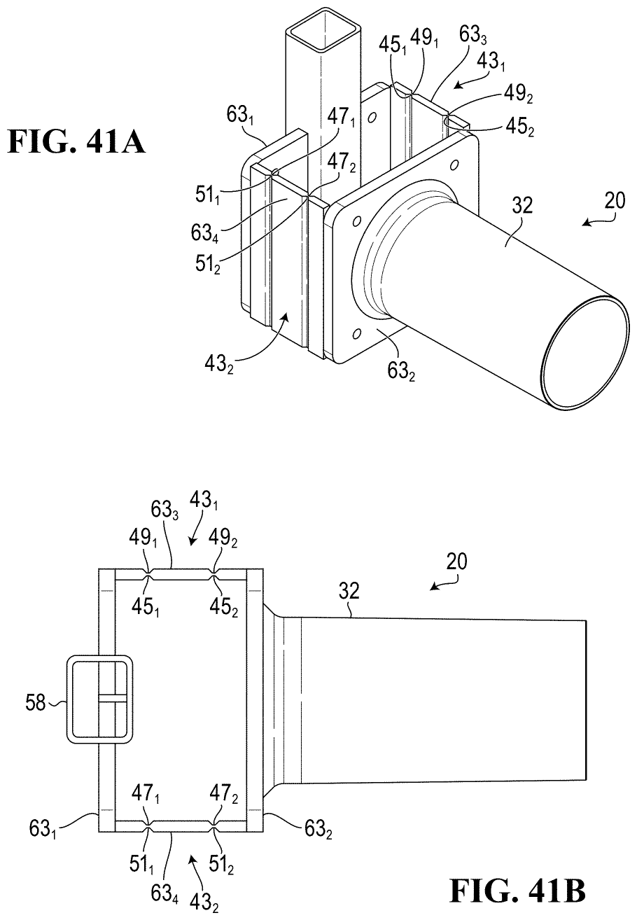

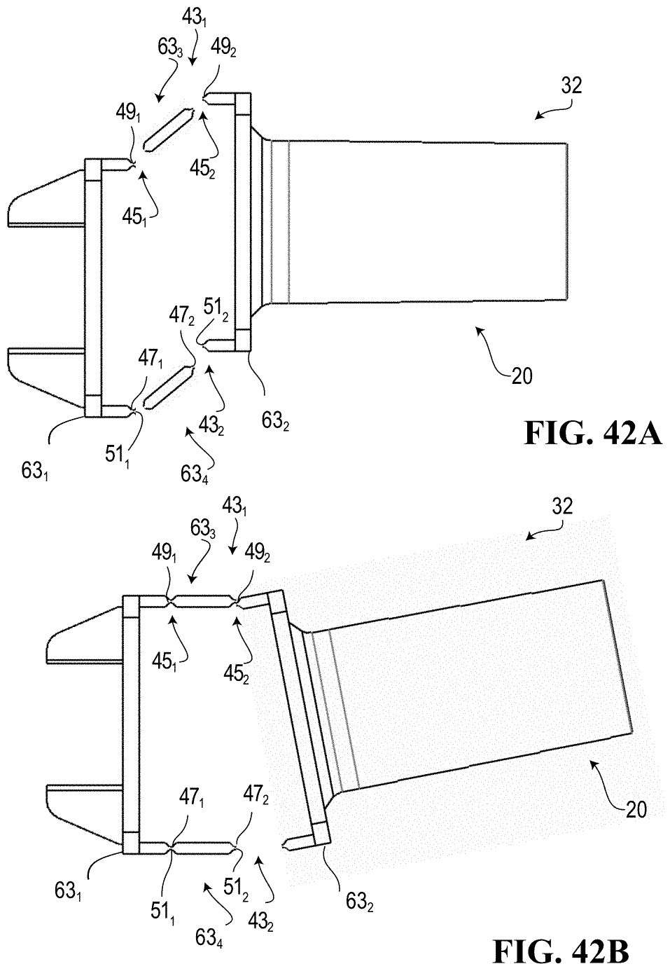

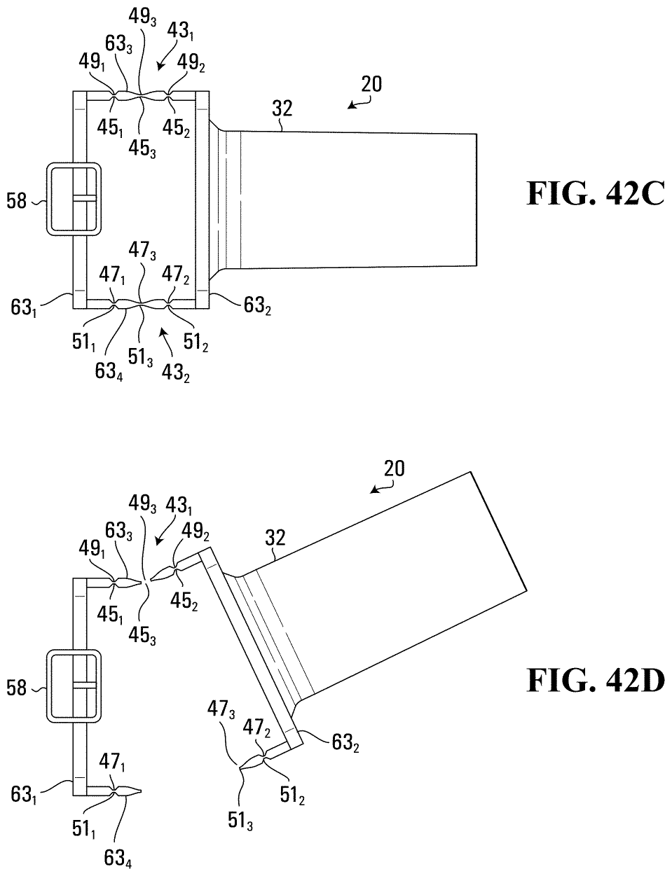

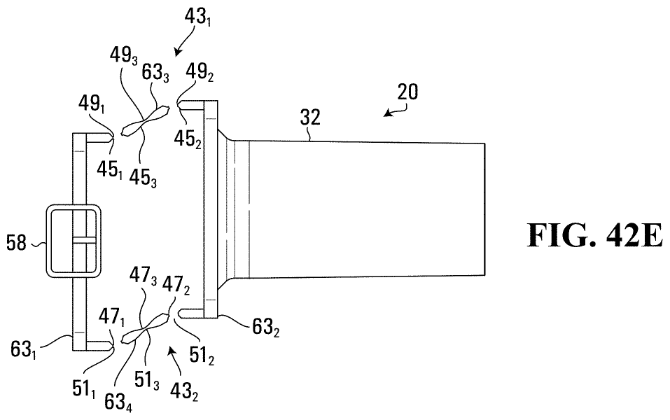

In one embodiment, the release mechanism 40 may comprise a third supporting member 63₃ and a fourth supporting member 63₄ that extend transversally to the base 63₁ and the arm carrier 632, as shown in FIGS. 41A, 41B, 42A and 42B. The third supporting member 63₃ comprises a first plate 43₁ and the fourth supporting member 63₄ comprises a second plate 43₂.

In this example of implementation, the third supporting member 63₃ comprises a zone of weakness 45 and the fourth supporting member 63₄ comprises a zone of weakness 47. The zone of weakness 45 of the third supporting members 63₃ comprises a constriction 49 and the zone of weakness 47 the fourth supporting member 63₄ comprises a constriction 51.

The zone of weakness 45 of the third supporting members 63₃ may be a first zone of weakness 45₁. The third supporting members 63₃ may comprise a second zone of weakness 45₂ spaced from the first zone of weakness 45₁. In other embodiments, the third supporting member 63₃ may comprise a third zone of weakness 45₃ spaced from the first zone of weakness 45₁ and the second zone of weakness 45₂.

The first zone of weakness 45₁ of the third supporting member 63₃ comprises a first constriction 49₁ of the third supporting member 63₃. The second zone of weakness 45₂ of the third supporting member 63₃ comprises a second constriction 49₂ of the third supporting member 63₃. The third zone of weakness 45₃ of the third supporting member 63₃ comprises a third constriction 49₃ of the third supporting member 63₃.

The zone of weakness 47 of the fourth supporting member 63₄ may be a first zone of weakness 47₁ and the fourth supporting member 63₄ may comprise a second zone of weakness 47₂ spaced from the first zone of weakness 47₁. In other embodiments, the fourth supporting member 63₄ may comprise a third zone of weakness 47₃ spaced from the first zone of weakness 47₁ and the second zone of weakness 47₂.

The first zone of weakness 47₁ of the fourth supporting member 63₄ comprises a first constriction 51₁ of the fourth supporting member 63₄ and the second zone of weakness 47₂ of the fourth supporting member 63₄ comprises a second constriction 51₂ of the fourth supporting member 63₄. The third zone of weakness 47₃ of the fourth supporting member 63₄ comprises a third constriction 51₃ of the fourth supporting member 63₄.

In one example of implementation of the above embodiment, the third and the fourth supporting members 63₃, 63₄ may be configured to be frangible to break in a particular location of the third and the fourth supporting members 63₃, 63₄ depending on if a maximum bending moment is applied to arm 20 or if a maximum shear force is applied to the arm 20. For example, as shown in FIG. 42D, if a maximum bending moment is applied to the arm 20 such that the arm 20 detaches from the support 58 in the flexion-based release mode, the third and the fourth supporting members 63₃, 63₄ are configured to be frangible to break in tension in a location generally corresponding to the third zone of weakness 45₃, 47₃ (i.e., the third constriction 49₃,51₃) of the third and the fourth supporting members 63₃, 63₄ thus breaking the connection 23 of the arm carrier 63₂ and the base 63₁. On the other hand, as shown in FIG. 42E, if a maximum shear force is applied to the arm 20 such that the arm 20 detaches from the support 58 in the shear-based release mode, the third and the fourth supporting members 63₃, 63₄ are configured to be frangible to break in flexion in locations generally corresponding to the first zone of weakness 45₁, 47₁ of the third and the fourth supporting members 63₃, 63₄ and the second zone of weakness 45₂, 47₂ of the third and the fourth supporting members 63₃, 63₄ (i.e., the first constrictions 49₁, 51₁ of the third and the fourth supporting members 63₃, 63₄ and the second constrictions 49₂, 51₂ of the third and the fourth supporting members 63₃, 63₄) allowing the arm carrier 63₂ to slidingly move relative to the base 63₁ thus breaking the connection 23 of the arm carrier 63₂ and the base 63₁.

In some embodiments, a shape of the third and the fourth supporting members 63₃, 63₄ and/or a dimension of the third and the fourth supporting members 63₃, 63₄ including a shape and/or a dimension of the zones of weakness 45₁, 45₂, 45₃, 47₁, 47₂, 47₃ (i.e., a shape and/or a dimension of the constrictions 49₁, 49₂, 49₃, 51₁, 51₂, 51₃) may reduce the possibility of fatigue failure of the third and the fourth supporting members 63₃, 63₄ (by improving fatigue resistance of the third and the fourth supporting members 63₃, 63₄) and may facilitate detachment of the arm 20 from the support 58.

For example, dimensions of the zones of weakness 45₁, 45₂, 45₃, 47₁, 47₂, 47₃(i.e., the constrictions 49₁, 49₂, 49₃, 51₁, 51₂, 51₃) of the third and the fourth supporting members 63₃, 63₄ may be chosen such that the fatigue resistance of the third and the fourth supporting members 63₃, 63₄ may be improved. For instance, the first zones of weakness 45₁, 47₁ and the second zones of weakness 45₂, 47₂(i.e., the first constrictions 49₁, 51₁ and the second constrictions 49₂, 51₂) of the third and the fourth supporting members 63₃, 63₄ may be configured to comprise a larger dimension (e.g., a larger cross-sectional area, width, diameter, or radius) than other portions of the third and the fourth supporting members 63₃, 63₄ (for example, a larger dimension than the third zone of weakness 45₃, 47₃ (i.e., the third constriction 49₃, 51₃) of the third and the fourth supporting members 63₃, 63₄) such that the fatigue resistance of the third and the fourth supporting members 63₃, 63₄ may be improved. Additionally or alternatively, a curvature or an angle of the third zone of weakness 45₃, 47₃ (i.e., the third constriction 49₃, 51₃) of the third and the fourth supporting members 63₃, 63₄ may be configured to be less acute (e.g., less sharp/comprise a larger radius of curvature) than other portions of the third and the fourth supporting members 63₃, 63₄ such that the fatigue resistance of the third and the fourth supporting members 63₃, 63₄ may be improved.

Moreover, dimensions of the zones of weakness 45₁, 45₂, 45₃, 47₁, 47₂, 47₃(i.e., the constriction 49₁, 49₂, 49₃, 51₁, 51₂, 51₃) of the third and the fourth supporting members 63₃, 63₄ may be chosen to facilitate detachment of the arm 20 from the support 58. In one example, the third zone of weakness 45₃, 47₃ (i.e., the third constriction 49₃, 51₃) of the third and the fourth supporting members 63₃, 63₄ may be configured to comprise a smaller dimension (e.g., a smaller cross-sectional area, width, diameter, or radius) than other portions of the third and the fourth supporting members 63₃, 63₄ (for example, a smaller dimension than the first zones of weakness 45₁, 47₁ and the second zones of weakness 45₂, 47₂ (i.e., the first constrictions 49₁, 51₁and the second constrictions 49₂, 51₂) of the third and the fourth supporting members 63₃, 63₄.) to facilitate detachment of the arm 20 from the support 58 in the flexion-based release mode. Additionally or alternatively, a curvature or an angle of the first zones of weakness 45₁, 47₁ and the second zones of weakness 45₂, 47₂ (i.e., the first constrictions 49₁, 51₁ and the second constrictions 49₂, 51₂) of the third and the fourth supporting members 63₃, 63₄ may be configured to be more acute (e.g., sharper/comprise a smaller radius of curvature) than other portions of the third and the fourth supporting members 63₃, 63₄ to facilitate detachment of the arm 20 from the support 58 in the shear-based release mode.

In one example of implementation of the above embodiment, the first zone of weakness 45₁, 47₁, the second zone of weakness 45₂, 47₂ and the third zone of weakness 45₃, 47₃ of the third and the fourth supporting members 63₃, 63₄ are configured to buckle the third and the fourth supporting members 63₃, 63₄ when the release mechanism 40 releases the arm 20.

In some embodiments, as shown in FIGS. 15B and 15C, the release mechanism 40 may comprise an alignment device 101 which may improve alignment of the respective ones of the fasteners 71₁-71_{F} with the respective ones of the recesses 41₁-41_{R} during installation of the fasteners 71₁-71_{F}. The alignment device 101 may reduce the potential of the base 63₁ and the arm carrier 63₂ sliding in the shear-based release mode. In one example of implementation of this embodiment, the alignment device 101 may be a plate 103. The plate 103 may comprise a plurality of recesses 105₁-105_{R}. Respective ones of the plurality of recesses 105₁-105_{R} of the plate 103 may be concentric with respective ones of the recesses 41₁-41_{R} of the base 63₁ and the arm carrier 63₂.

In some embodiments, as shown in FIGS. 15B and 15C, the release mechanism 40 may comprise a plate 107 lying between the base 63₁ and the arm carrier 63₂. The plate 107 may help reduce friction between the base 63₁ and the arm carrier 63₂. The plate 107 may be made of any suitable material (e.g. a low-friction polymeric material).

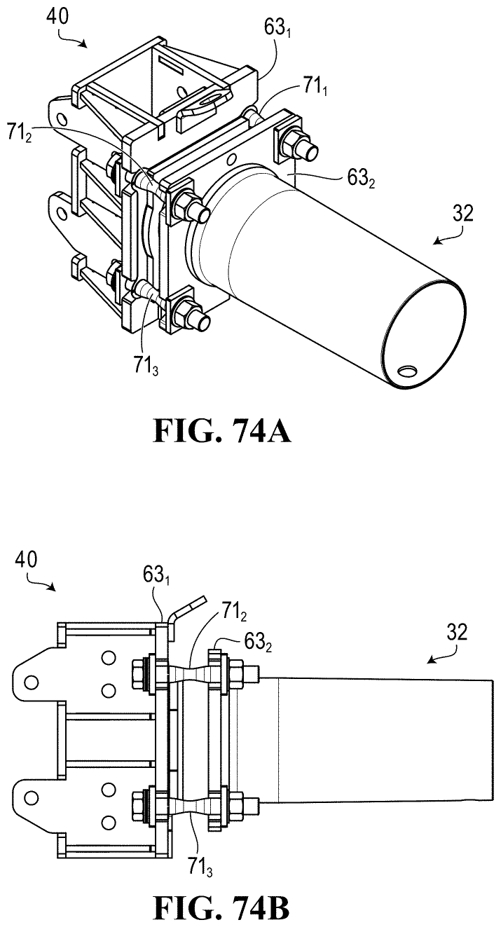

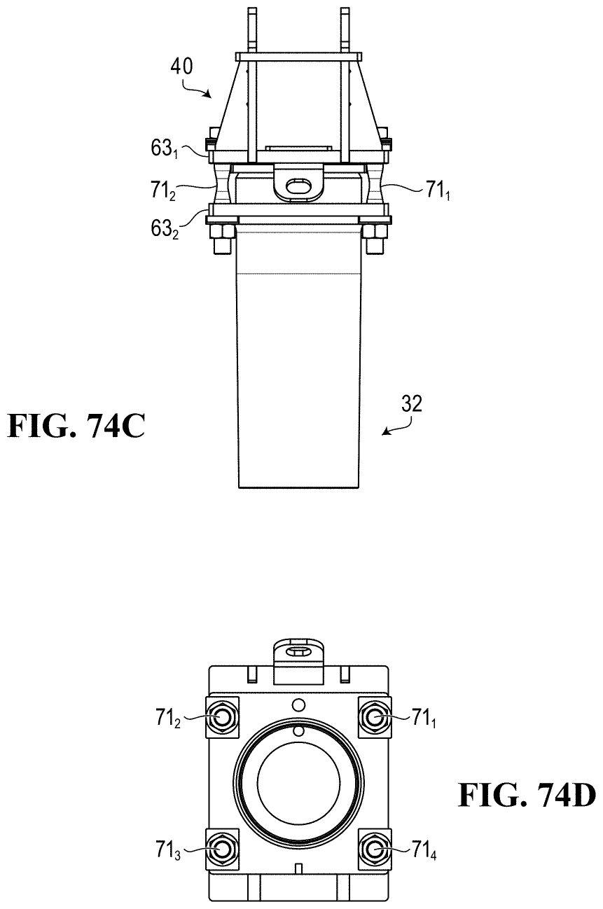

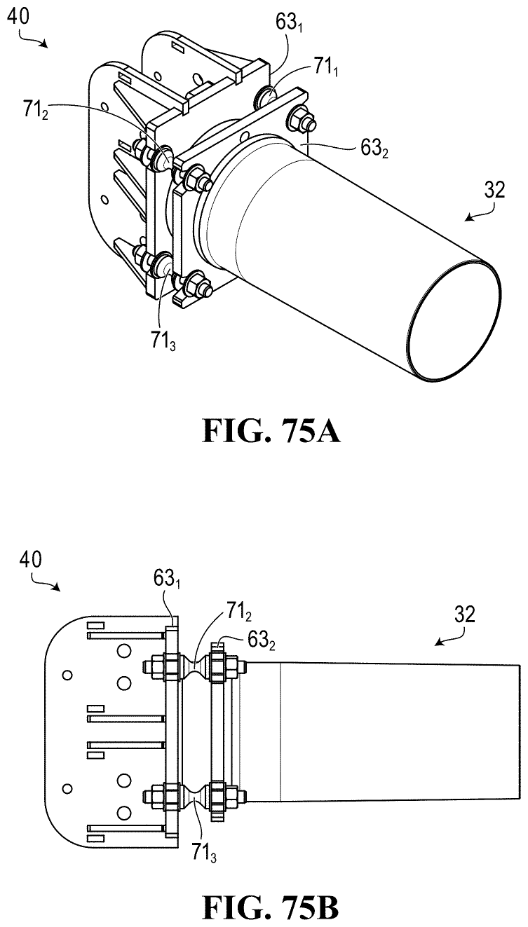

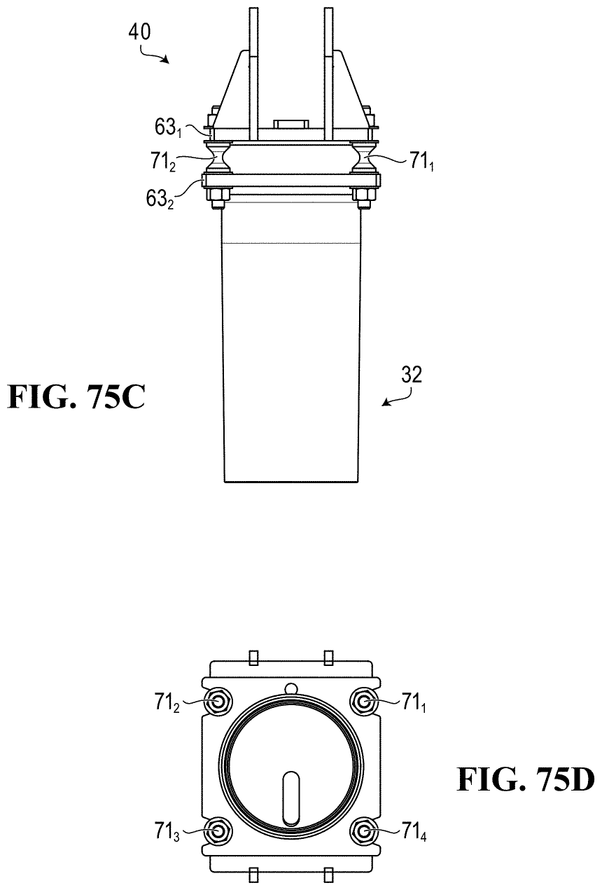

As yet another example, a variety of embodiments of the release mechanism 40 are shown in FIGS. 73A, 73B, 73C, 74A, 74B, 74c, 75A, 75B, 75C and 75D. The release mechanism 40 may have any other suitable configuration.

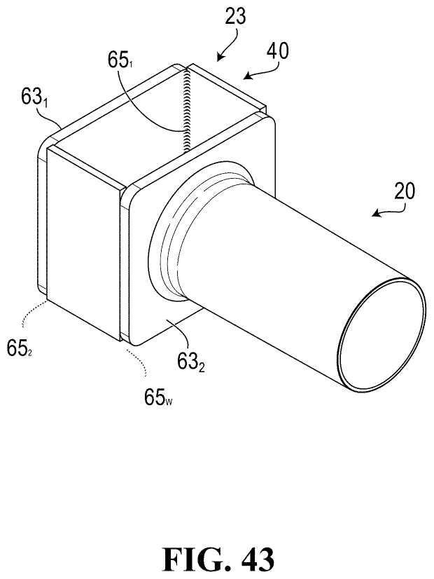

The connection 23 of the arm carrier 63₂ and the base 63₁ may be configured in any suitable fashion. For example, in one embodiment, the connection 23 may comprise a plurality of welds 65₁-65_{W}, as shown in FIG. 43. The plurality of welds 65₁-65_{W} may be configured such that the arm 20 may detach from the control system 30 in the flexion-based release mode when a predetermined bending moment has been applied to the plurality of welds 65₁-65_{W} and the arm 20 may detach from the control system 30 in the shear-based release mode when a predetermined shear force has been applied to the plurality of welds 65₁-65_{W}.

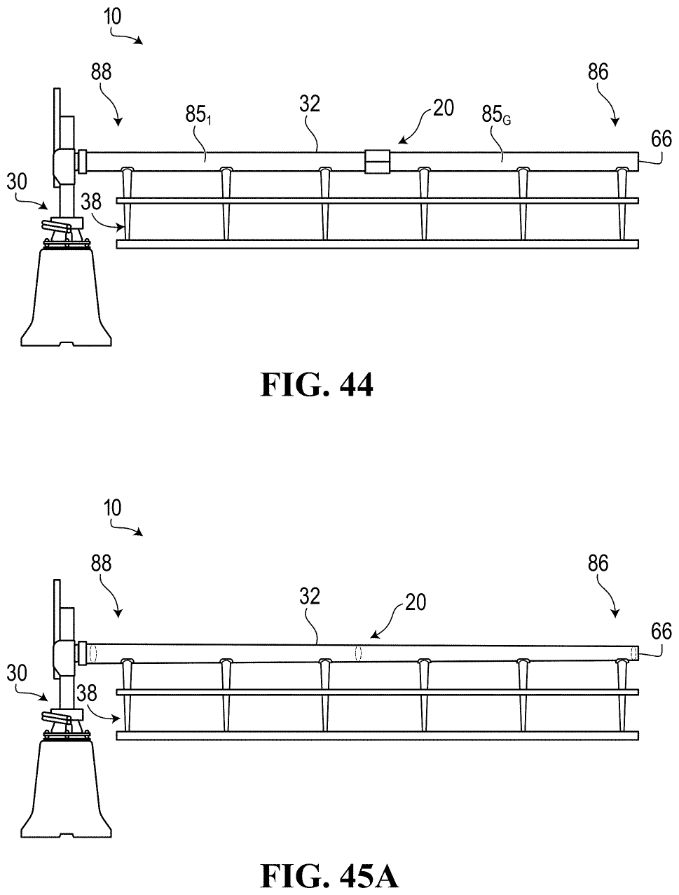

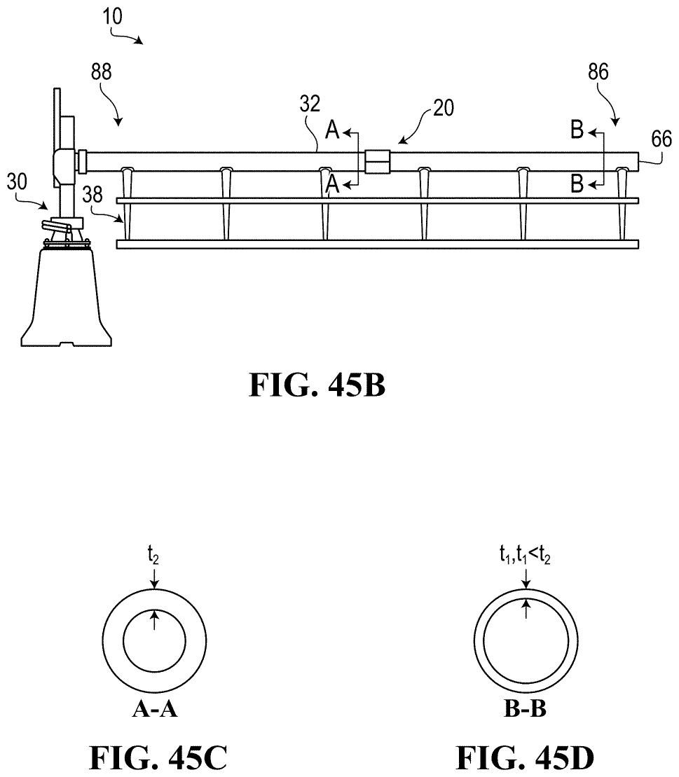

For example, in some embodiments, as shown in FIGS. 44 and 45, the arm 20 may have a linear weight, i.e., a weight per unit length, that varies in the longitudinal direction of the arm 20 such that a distal part 86 of the arm 20 may be lighter than a proximal part 88 of the arm 20 to reduce a moment at the control system 30. For instance, in some embodiments, as shown in FIG. 44, the beam 32 may comprise a plurality of materials 85₁-85_{G} that are different from one another along respective portions of the arm 20. For instance, in some embodiments, the material 85_{G} of the beam 32 in the distal part 86 of the arm 20 may be less dense than the material 851 of the beam 32 in the proximal part 88 of the arm 20.

Alternatively or additionally, as shown in FIG. 45A, a cross-section of the beam 32 may vary along respective portions of the arm 20. For instance, in some embodiments, the cross-section of the beam 32 in the distal part 86 of the arm 20 may be smaller than the cross-section of the beam 32 in the proximal part 32 of the arm 20. Alternatively or additionally, as shown in FIG. 45B, 45C and 45D, a thickness t of the beam 32 may vary along respective portions of the arm 20. For instance, in some embodiments, the thickness t₁ of the beam 32 in the distal part 86 of the arm 20 may be smaller than the thickness t₂ of the beam 32 in the proximal part 32 of the arm 20.

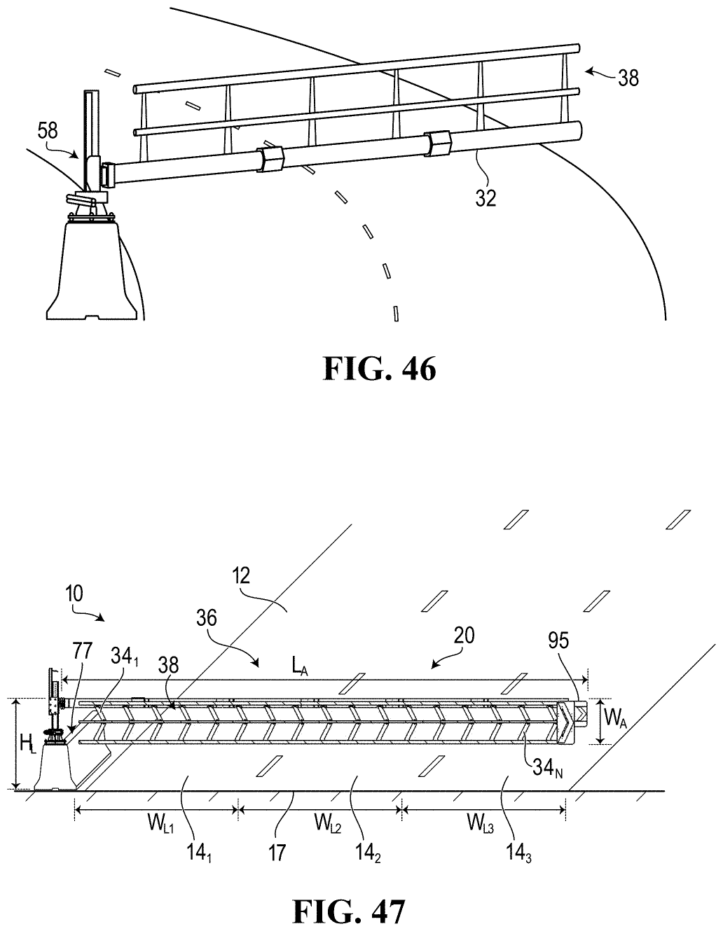

As another example, in some embodiments, as shown in FIG. 46, the beam 32 may be located lower and the visible arrangement 38 may project upwardly from beam 32. For instance, in some embodiments, this may be achieved by inversing what is described above in respect of the beam 32 and the visible arrangement 38. In some embodiments, the beam 32 may be located such that it would not be cleared by an oncoming vehicle such as a passenger car or a pickup truck. In such cases, the beam 32 may be positioned lower than a windshield for these vehicles, such as at a bumper level, to reduce impact to their windshield.

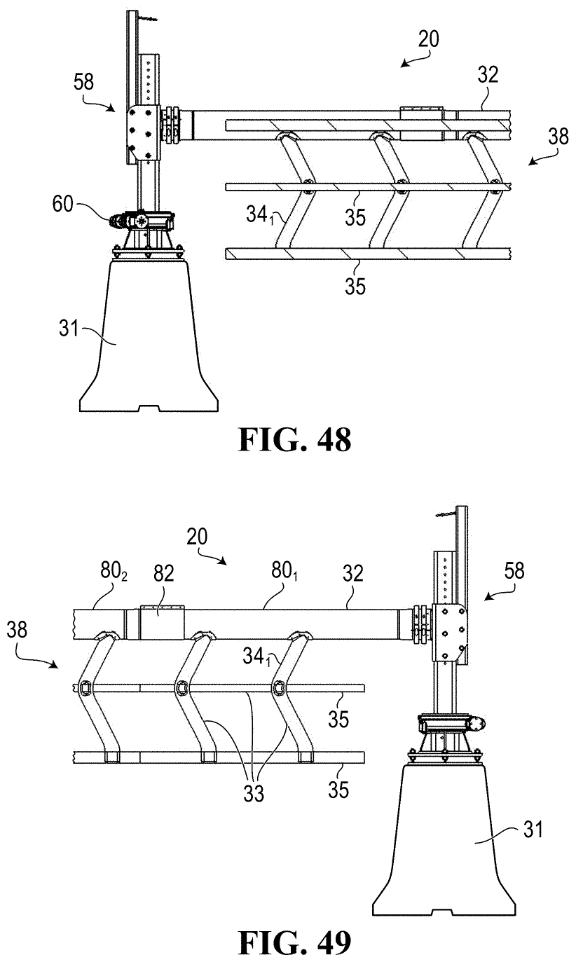

As another example, in some embodiments, the visible arrangement 38 may be constructed in any other suitable manner. For instance, in some embodiments, as shown in FIGS. 47 to 49 and 52, transversal visible members 34₁-34_{N} may extend obliquely to the longitudinal direction of the beam 32. In this example, the transversal visible members 34₁-34_{N} are disposed in an arrow-like manner to point in a direction (i.e., here towards the right) indicative of where the oncoming traffic should go in view of closure effected by the gate 10. Also, in some embodiments, the arm 20 may comprise a sign 95 informing of (e.g., pointing in) the direction indicative of where the oncoming traffic should go in view of closure effected by the gate 10. For instance, in this embodiment, as shown in FIGS. 53 and 54, the sign 95 may be a chevron sign. In some examples, the sign 95 may be illuminatable, i.e., comprise a light source 93 to illuminate the sign 95. The light source 93 may comprise light-emitting diodes (LEDs) or any other suitable light-emitting element.

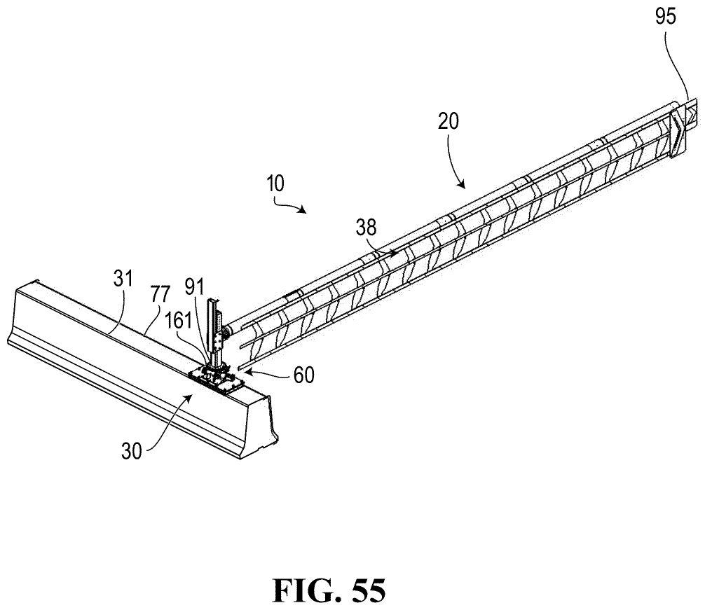

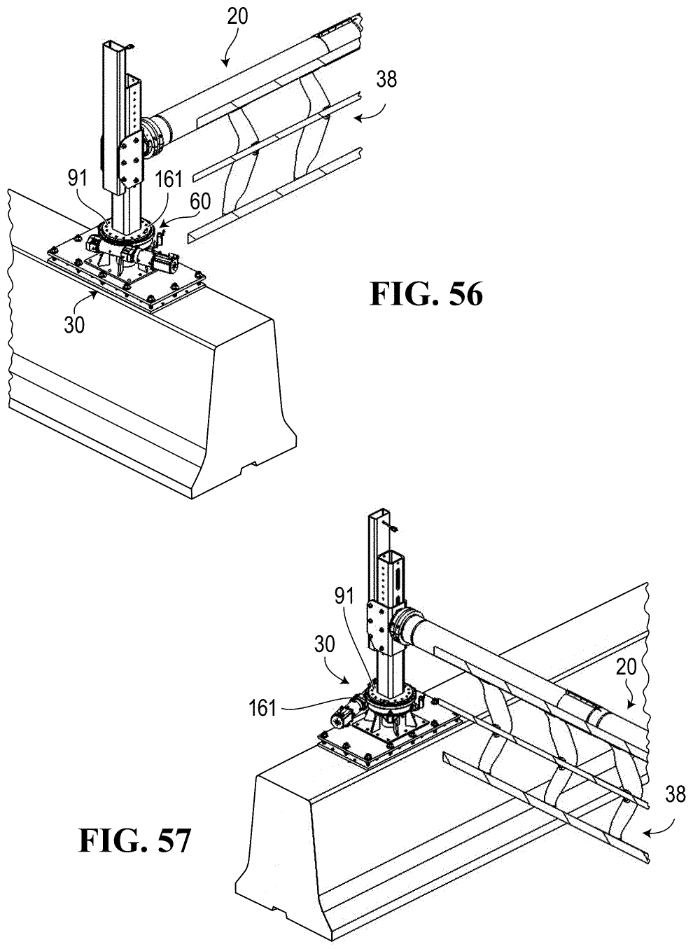

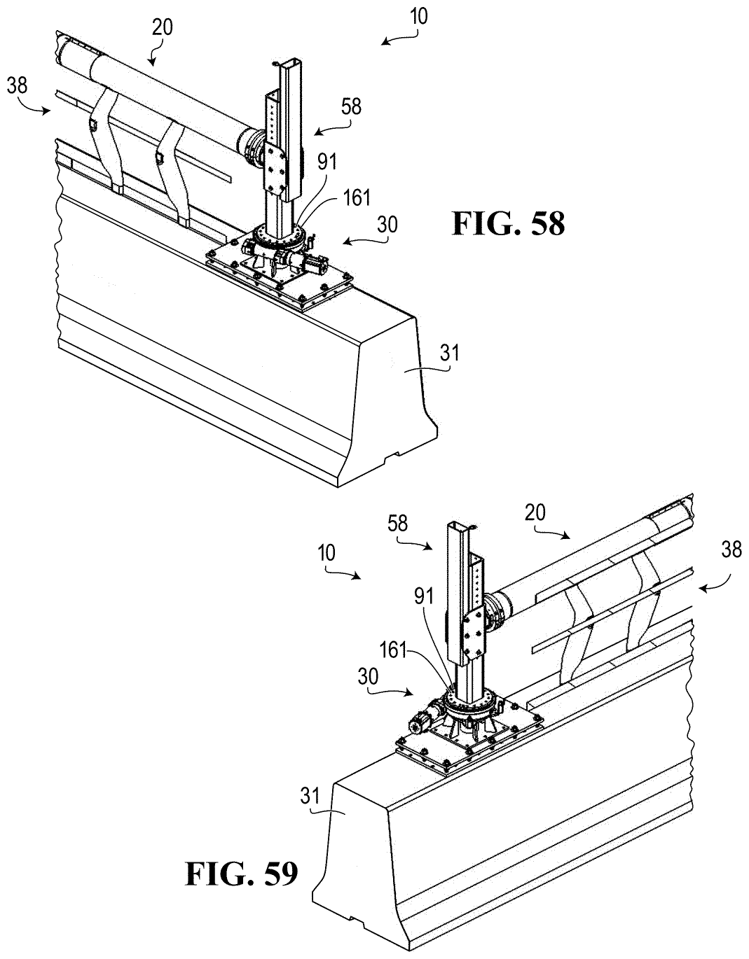

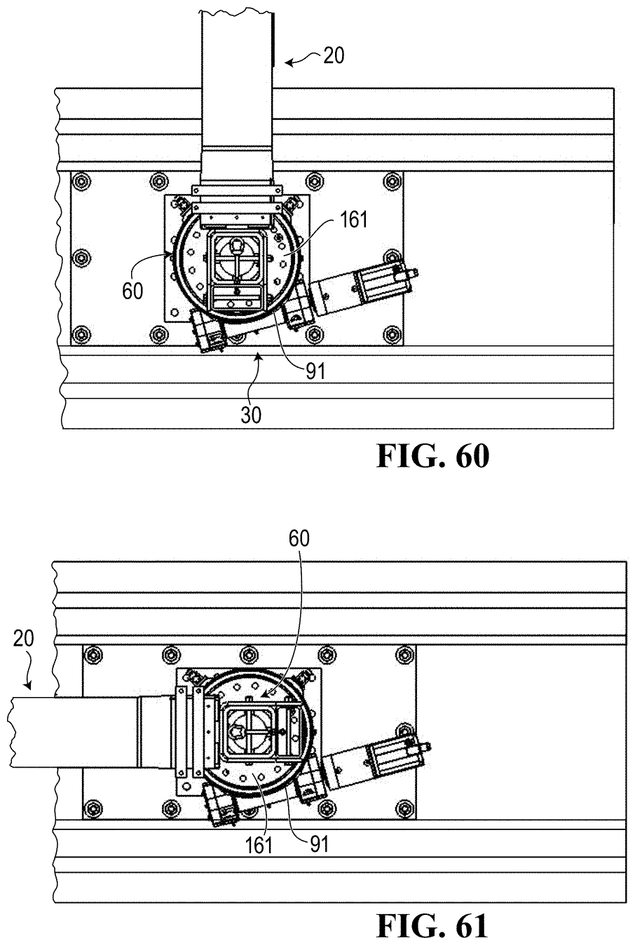

As another example, in some embodiments, the control system 30 may be implemented in any other suitable way. For instance, in some embodiments, as shown in FIGS. 55 to 61, the actuator 60 may comprise a rotary actuator 161, For example, in this embodiment, the rotary actuator 161 comprises a slewing drive 91 that includes a worm gearbox. This may provide high torque and high strength in a small size. In this case, the control system 30 may be without any linear actuator. This may help for compactness of the control system 30.

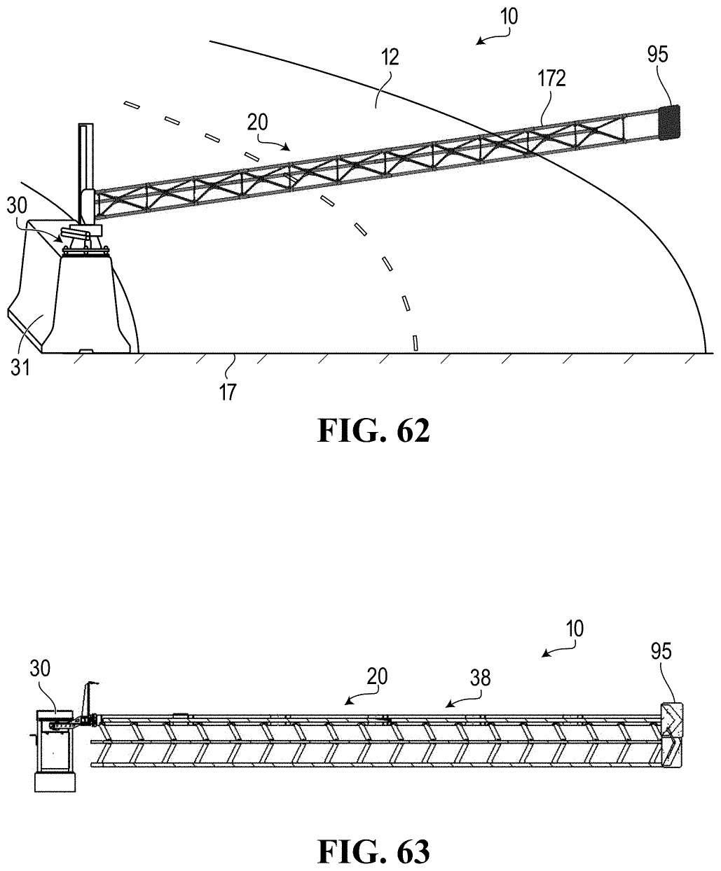

As another example, in some embodiments, as shown in FIG. 62, the arm 20 may comprise an aluminum truss 172. In some situations, the aluminum truss 172 may provide the structural integrity of the arm 20 instead of using a beam such as the beam 32 discussed above to increase a stiffness and a strength of the arm 20, thereby potentially reducing a deflection of the arm 20. The aluminum truss 172 may thus be used in some situations to alleviate the deflection of the arm 20 that is cantilevered and allow the arm 20 to span over longer distances (e.g. large roadways, bridges/tunnels, country roads) without jeopardizing the utility and operability of the gate 10. This may however affect a capacity of the gate 10 to be crash-tested.

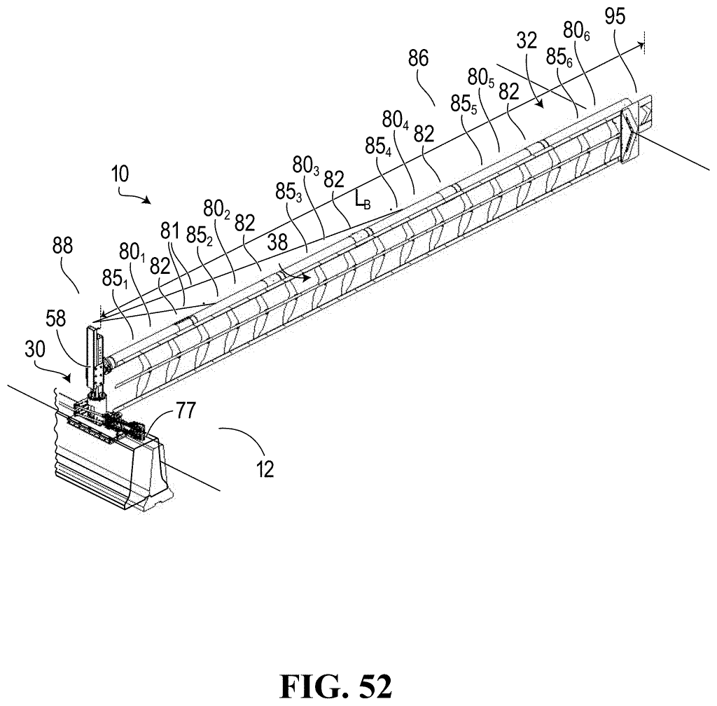

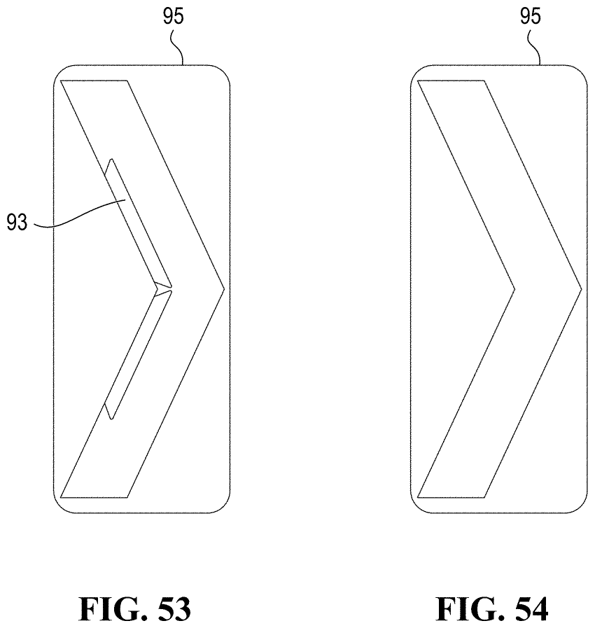

As another example, in other embodiments, as shown in FIGS. 14A, 14B, 14C and 52, the arm 20 may comprise a cable 81 (e.g., a wire cable) connecting the support 58 of the control system 30 to the beam 32 at a location along its length to counter a tendency of the arm 20 to deflect along its span. In one example of this embodiment, the cable 81 may comprise a release mechanism 97 configured to release the cable 81 from the support 58 as shown in FIG. 14C. The release mechanism 97 allows the cable 81 to detach from the support 58 of the arm 20 if the arm is in its extended position and impacted by a large vehicle, The release mechanism 97 is configured such that it comprises a “flexion-based” release mode, is at least mainly (i.e., mainly or entirely) caused by a bending moment M at the release mechanism 97. The release mechanism 97 comprises a zone of weakness 99.

As another example, in some embodiments, the release mechanism 40 may be configured to release the arm 20 if the arm 20 is in its extended position and impacted by a vehicle that is relatively large, without detaching the arm 20 from the control system 30. For example, in some embodiments, the release mechanism 40 may be configured to release the arm 20 so that the arm 20 is freely supported at (e.g., hangs from) the control system 30, i.e., is “unlocked” or otherwise unconstrained to remain in its extended position and possibly drops toward the surface 17 of the roadway 12, but remains attached to the control system 30, In some embodiments, the release mechanism 40 may be configured such that, in the flexion-based release mode, the bending moment may cause the arm 20 to pivot about the control system 30 rather than detach from the control system 30.

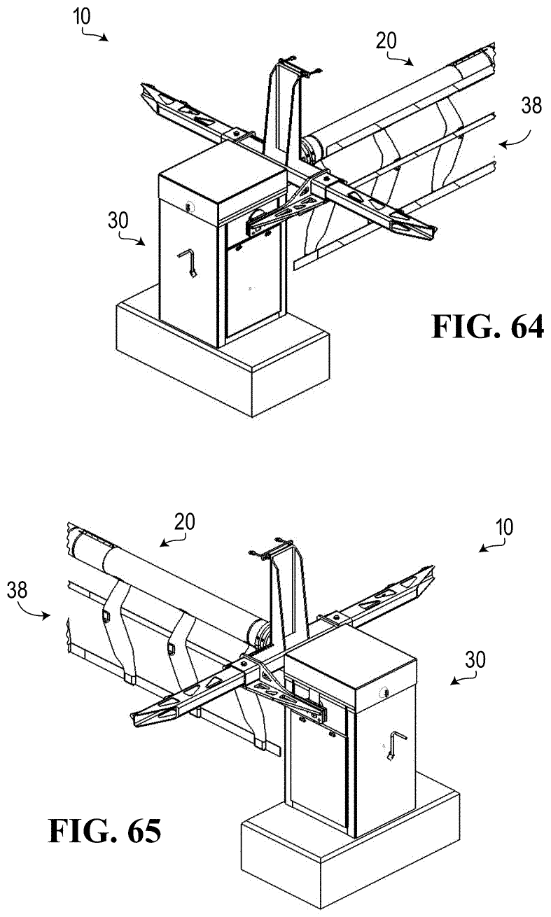

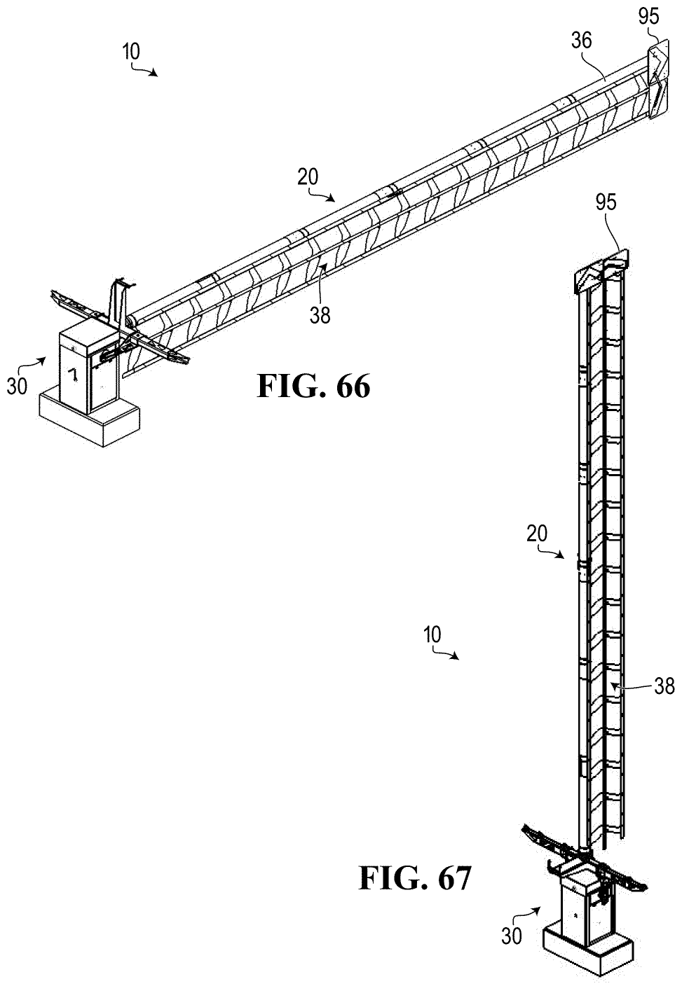

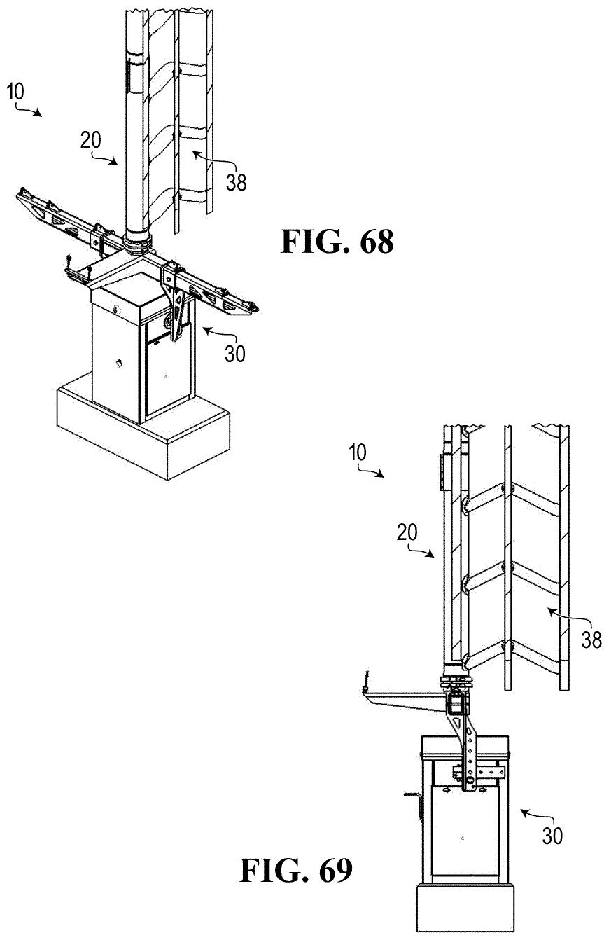

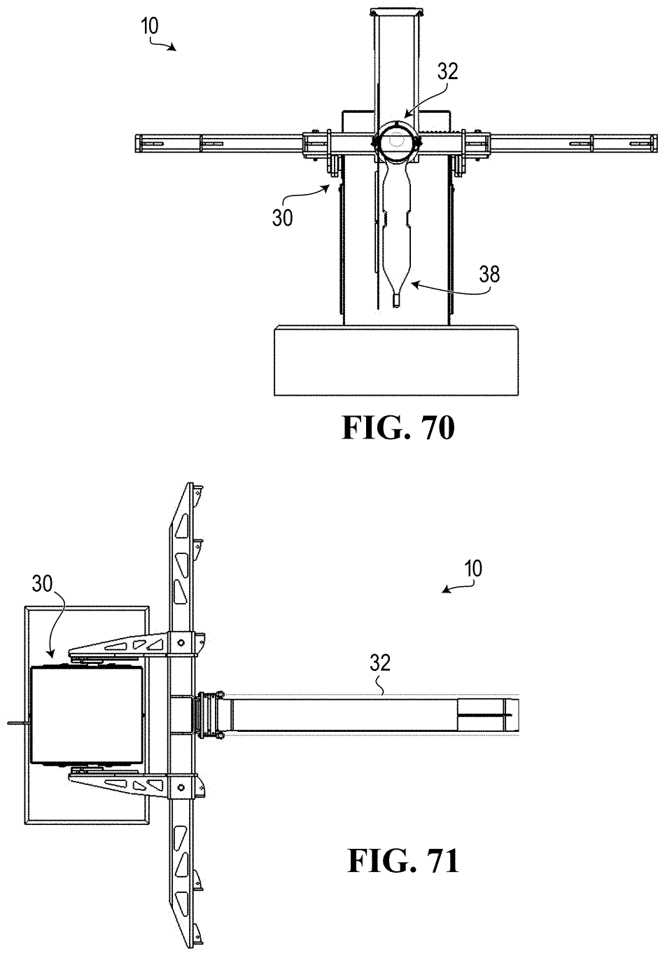

As another example, in other embodiments, as shown in FIGS. 63 to 71, the control system 30 may be configured such that the arm 20 is movable vertically, instead of horizontally, relative to the control system 30 between its extended position and its retracted position. In yet other embodiments, the control system 30 may be configured such that the arm 20 is movable obliquely, rather than only horizontally or only vertically, relative to the control system 30 between its extended position and its retracted position.

As another example, in other embodiments, the gate 10 may be mounted in any other suitable way at the roadway 12. For instance, in some embodiments, the traffic barrier 31 may be any other type of traffic barrier (e.g., a roadside barrier, any type of wall). In other embodiments, the gate 10 may be mounted to a pedestal (e.g, a concrete platform which may be embedded into the ground). Also, in some embodiments, the gate 10 may be mounted on a right side of the roadway 12 instead of on a left side of the roadway 12 as shown in embodiments considered above.

Although embodiments considered above pertain to the gate 10 and its arm 20, the apparatus 10 for use in respect of traffic on the roadway 12 and its traffic-related device 20 may be any other apparatus and traffic-related device to manage, assist or otherwise be useful for the traffic on the roadway 12 and may include the release mechanism 40 in other embodiments.

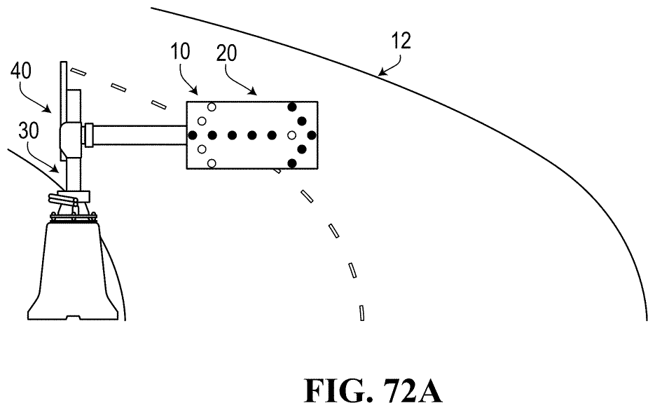

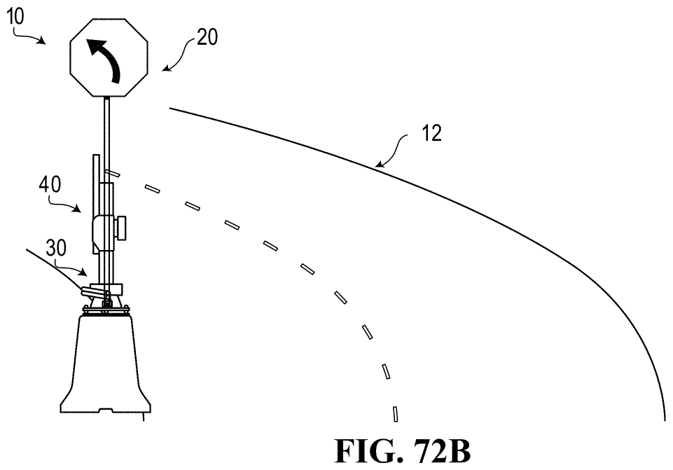

For example, in some embodiments, as shown in FIGS. 72A and 72B, the apparatus 10 may be a signage apparatus for managing the traffic on the roadway 12 such that the traffic-related device 20 is a sign. In this embodiment, the signage apparatus 10 is an automated signage system, the sign 20 is an automated sign that can be moved between an extended position and a retracted position by the control system 30, and the release mechanism 40 is configured to release the sign 20 (e.g., detach the sign 20 from the control system 30) if the sign 20 is in its extended position and impacted by a vehicle, similarly to what was discussed above.

While embodiments considered above refer to the roadway 12 as being outdoors, in some embodiments, the roadway 12 may be any area on which vehicles or other traffic can circulate, including indoors (e.g., in tunnels, warehouses, etc.).

In other embodiments, the apparatus 10 may be used for a purpose unrelated to traffic and be subject to being impacted, so that it benefits from the release mechanism 40.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Any feature of any embodiment discussed herein may be combined with any feature of any other embodiment discussed herein in some examples of implementation.

In case of any discrepancy, inconsistency, or other difference between terms used herein and terms used in any document incorporated by reference herein, meanings of the terms used herein are to prevail and be used.

Although various embodiments and examples have been presented, this was for purposes of description, but should not be limiting, Various modifications and enhancements will become apparent to those of ordinary skill in the art.

1. A gate for controlling oncoming traffic on a roadway, the gate comprising:
an arm movable between an extended position in which the arm extends into a given portion of the roadway to inform the oncoming traffic that the given portion of the roadway is closed and a retracted position in which the arm does not extend into the given portion of the roadway; and
a control system comprising an actuator and configured to support the arm and move the arm between the extended position and the retracted position, the control system comprising a release mechanism configured to release the arm when the arm is in the extended position and impacted by a vehicle, the release mechanism being configured to release the arm in any one of a plurality of release modes that are different based on where the arm is impacted by the vehicle.

2. The gate of claim 1, wherein the release mechanism is configured such that: a first one of the release modes is at least mainly caused by a bending moment at the release mechanism; and a second one of the release modes is at least mainly caused by a shear force at the release mechanism.

3. The gate of claim 2, wherein the release mechanism is configured such that: the bending moment is sufficient to cause the arm to be released but insufficient to impair the control system outside of the release mechanism; and the shear force is sufficient to cause the arm to be released but insufficient to impair the control system outside of the release mechanism.

4. The gate of claim 2, wherein: the release mechanism is configured to release the arm in the first one of the release modes when the arm is impacted by the vehicle at a first location on the arm; and the release mechanism is configured to release the arm in the second one of the release modes when the arm is impacted by the vehicle at a second location on the arm that is closer to the control system than the first location on the arm.

5. The gate of claim 4, wherein: the first location on the arm is located between an intermediate point of the arm and a distal end of the arm in a longitudinal direction of the arm; and the second location on the arm is located between the intermediate point of the arm and a proximal end of the arm in the longitudinal direction of the arm.

6. The gate of claim 1, wherein the release mechanism is configured to release the arm by detaching the arm from the control system.

7. The gate of claim 6, wherein the release mechanism is configured to detach the arm from the control system as one piece.

8. The gate of claim 6, wherein the release mechanism is configured to detach the arm from the control system as one piece in front of the vehicle.

9. The gate of claim 2, wherein: the control system comprises a support supporting the arm and including the release mechanism; and the release mechanism comprises a plurality of supporting members of the support that are movable relative to one another to release the arm.

10. The gate of claim 9, wherein: the release mechanism is configured to release the arm by detaching the arm from the control system; and respective ones of the supporting members are configured to detach from one another to detach the arm.

11. The gate of claim 9, wherein a first one of the supporting members is a base and a second one of the supporting members is an arm carrier that carries the arm and is movable relative to the base to release the arm.

12. The gate of claim 11, wherein the arm carrier is configured to be released with the arm when the releasing mechanism releases the arm.

13. The gate of claim 12, wherein the arm carrier is configured to be detached from the base when the releasing mechanism releases the arm.

14.-15. (canceled)

16. The gate of claim 11, wherein the arm carrier is configured to slidingly move relative to the base in the second one of the release modes.

17. The gate of claim 11, wherein: the release mechanism comprises a connection of the arm carrier and the base; and the connection of the arm carrier and the base is frangible to break in the first release mode and allows the arm carrier to slidingly move relative to the base in the second release mode.

18. The gate of claim 17, wherein the connection of the arm carrier and the base comprises a plurality of fasteners.

19. The gate of claim 18, wherein the fasteners are frangible to release the arm.

20. The gate of claim 19, wherein each fastener comprises a zone of weakness.

21. The gate of claim 20, wherein the zone of weakness of the fastener includes a constriction of the fastener.

22. The gate of claim 18, wherein: the base and the arm carrier comprises recesses receiving the fasteners; and respective ones of the fasteners are configured to slidingly move out of respective ones of the recesses to release the arm.

23. The gate of claim 18, wherein the fasteners are preloaded in tension.

24. The gate of claim 23, wherein the release mechanism comprises a plurality of washers engaging the fasteners to preload the fasteners.

25.-27. (canceled)

28. The gate of claim 20, wherein: the zone of weakness of the fastener is a first zone of weakness; and the fastener comprises a second zone of weakness spaced from the first zone of weakness.

29. (canceled)

30. The gate of claim 28, wherein the fastener comprises a third zone of weakness spaced from the first zone of weakness and the second zone of weakness of the fastener.

31. (canceled)

32. The gate of claim 30, wherein the first zone of weakness, the second zone of weakness and the third zone of weakness of the fastener are configured to buckle the fastener when the release mechanism releases the arm.

33. The gate of claim 20, wherein the zone of weakness of the fastener is a zone of directional weakness of the fastener.

34. The gate of claim 21, wherein the zone of weakness of the fastener includes a constriction of the fastener in only a single direction.

35. The gate of claim 11, wherein a third one of the supporting members and a fourth one of the supporting members extend transversally to the base and the arm carrier.

36. (canceled)

37. The gate of claim 35, wherein the third one of the supporting members comprises a zone of weakness and the fourth one of the supporting members comprises a zone of weakness.

38. The gate of claim 37, wherein the zone of weakness of the third one of the supporting members comprises a constriction and the zone of weakness of the fourth one of the supporting members comprises a constriction.

39. and 40. (canceled)

41. The gate of claim 1, wherein the given portion of the roadway includes a lane and the arm is configured to be longer than a width of the lane in the extended position.

42. to 48. (canceled)

49. The gate of claim 1, wherein a height of a longitudinal part of the arm in the extended position from a surface of the roadway is greater than a height of a passenger car complying with MASH crash-testing.

50. The gate of claim 1, wherein a height of a longitudinal part of the arm in the extended position from a surface of the roadway is no less than a height of a pickup truck complying with MASH crash-testing.

51. The gate of claim 1, wherein the arm comprises: a beam extending along a longitudinal direction of the arm; and a visible arrangement supported by the beam.

52.-66. (canceled)

67. The gate of claim 1, wherein the arm is movable horizontally relative to the control system between the extended position and the retracted position.

68. The gate of claim 1, wherein the actuator is configured to cause pivoting of the arm between the extended position and the retracted position.

69. to 84. (canceled)

85. The gate of claim 1, wherein the release mechanism is configured to release the arm if the vehicle is larger than a pickup truck.

86. The gate of claim 85, wherein the arm is unreleased by the release mechanism if the vehicle is no larger than the pickup truck.

87. to 90. (canceled)

91. A gate for controlling oncoming traffic on a roadway, the gate comprising:
an arm movable between an extended position in which the arm extends into a given portion of the roadway to inform the oncoming traffic that the given portion of the roadway is closed and a retracted position in which the arm does not extend into the given portion of the roadway; and
a control system comprising an actuator and configured to support the arm and move the arm between the extended position and the retracted position, the control system comprising a release mechanism configured to release the arm when the arm is in the extended position and impacted by a vehicle, the release mechanism being configured to release the arm:
at least mainly due to a bending moment at the release mechanism when the arm is impacted by the vehicle at a first location; and
at least mainly due to a shear force at the release mechanism when the arm is impacted by the vehicle at a second location closer to the control system than the first location.

92. A gate for controlling oncoming traffic on a roadway, the gate comprising:
an arm movable between an extended position in which the arm extends into a given portion of the roadway to inform the oncoming traffic that the given portion of the roadway is closed and a retracted position in which the arm does not extend into the given portion of the roadway; and
a control system comprising an actuator and configured to support the arm and move the arm between the extended position and the retracted position, the control system comprising a release mechanism configured to detach the arm from the control system when the arm is in the extended position and impacted by a vehicle, the release mechanism being configured to detach the arm from the control system in response to a bending moment at the release mechanism.

93.-99. (canceled)
